(19) United States
(12) Patent Application Publication
(10) Pub. No.: US 2023/0317959 A1
(43) Pub. Date: Oct. 5, 2023

(54) ELECTRICALLY CONDUCTIVE RELEASE LAYER

(71) Applicant: Sion Power Corporation, Tucson, AZ (US)

(72) Inventors: Igor P. Kovalev, Vail, AZ (US); Alexis Sheffield, Tucson, AZ (US)

(73) Assignee: Sion Power Corporation, Tucson, AZ (US)

(21) Appl. No.: 18/024,229

(22) PCT Filed: Sep. 4, 2020
(86) PCT No.: PCT/US2020/049438

§ 371 Date: Mar. 1, 2023

(51) Int. Cl. H01M 4/62; H01M 4/04; C09D 5/24; C09D 7/61; C09D 7/40; C09D 181/06

(52) U.S. Cl. CPC H01M 4/625; H01M 4/622; H01M 4/0404; H01M 4/0409; H01M 4/0471; C09D 5/24; C09D 7/61; C09D 7/67; C09D 181/06; C08K 3/041

(57) ABSTRACT

Electrochemical cells, and more specifically, release systems for the fabrication of electrochemical cells are described. The release layers described herein may be conductive release layers. In particular, conductive release layer arrangements, assemblies, methods and compositions that facilitate the fabrication of electrochemical cell components, such as electrodes, are presented. In some embodiments, methods of fabricating an electrode involve the use of a release layer to separate portions of the electrode from a carrier substrate on which the electrode was fabricated. For example, an intermediate electrode assembly may include, in sequence, an electroactive layer, an optional current collector layer, a conductive release layer, and a carrier substrate.

### FIELD OF INVENTION

The present disclosure generally relates to release systems including conductive release layers for electrochemical cells.

### BACKGROUND

A typical electrochemical cell includes a cathode and an anode which participate in an electrochemical reaction. To fabricate an electrode, an electroactive layer may be deposited onto a component of the electrochemical cell such as a current collector. In turn, the current collector may be supported by a substrate that has suitable physical and chemical properties (e.g., a substantial thickness) that allow it to be compatible with the processes required to form the electrode. Some such substrates, however, may have little or no function in the electrochemical cell; therefore, their incorporation into the cell adds additional weight but does not substantially increase performance. Accordingly, alternative articles or methods that would eliminate the need or reduce the weight of non-functioning components of an electrochemical cell would be beneficial. Fabrication of other electrochemical cell components may also benefit from such alternative articles and methods.

### SUMMARY OF THE INVENTION

Electrochemical cells, and more specifically, conductive release systems for electrochemical cells are provided. The subject matter of the present disclosure involves, in some cases, interrelated products, alternative solutions to a particular problem, and/or a plurality of different uses of one or more systems and/or articles.

In one aspect, a conductive release layer for releasing an electrode from a substrate is described. The conductive release layer may comprise a plurality of conductive carbon species comprising a plurality of conductive carbon particles and a plurality of elongated carbon structures. The conductive release layer may also comprise a polymeric binder.

In another aspect, a conductive release layer for releasing an electrode from a substrate is described comprising a plurality of conductive carbon species comprising elemental carbon and a polymeric binder, wherein the plurality of conductive carbon species is present in an amount of greater than or equal to 15 wt % of the conductive release layer.

In another aspect, an electrode comprising an electroactive layer and a conductive release layer adjacent to the electroactive layer, wherein the conductive release layer comprises a plurality of conductive carbon species, and wherein the conductive carbon species comprises elemental carbon is described.

In yet another aspect, an electrode is described comprising an electroactive layer and a conductive release layer, wherein the conductive release layer comprises a polymeric binder and a plurality of conductive carbon species, and wherein the plurality of conductive carbon species is present in an amount of greater than or equal to 15 wt % relative to an amount of the polymeric binder.

In yet another aspect, an electrode is described comprising a first electroactive layer, a first conductive release layer comprising a plurality of conductive carbon species, and a second electroactive layer, wherein the first conductive release layer is between the first electroactive layer and the second electroactive layer, and wherein the first electroactive layer is in electronic communication with the second electroactive layer.

In a yet another aspect, a method is described. The method comprises dissolving a polymeric binder in a solvent to form a solution, adding a plurality of conductive carbon species to the solution to form a slurry, dispersing the plurality of conductive carbon species within the slurry, evaporating the solvent from the slurry to form a conductive release layer, and depositing a current collector or an electroactive layer on the conductive release layer.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control. All patents and patent applications disclosed herein are incorporated by reference in their entirety for all purposes.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is schematic diagram of a conductive release layer, according to some embodiments;

FIG. 2A-21 schematically illustrate a method of forming a release layer on a substrate, according to some embodiments;

FIG. 3A shows an electrode assembly including an electroactive layer, a current collector, a conductive release layer, and a carrier substrate according to one set of embodiments;

FIG. 3B shows an electrode formed by the use of the conductive release layer and carrier substrate shown in FIG. 3A according to one set of embodiments;

FIG. 4A shows the joining of two electrodes to form an electrode assembly according to one set of embodiments; and

FIG. 4B shows an electrode assembly formed by the process shown in FIG. 4A according to one set of embodiments.

### DETAILED DESCRIPTION

The present disclosure relates generally to electrochemical cells, and more specifically, to release systems for the fabrication of electrochemical cells. In particular, release layer (e.g., conductive release layer) arrangements, assemblies, methods and compositions that facilitate the fabrication of electrochemical cell components, such as electrodes, are presented. In some embodiments, the release layer is a conductive release layer that can conduct electrons (e.g., an electronically-conductive release layer), for example, from one portion of the conductive release layer (e.g., a first surface) to another portion of the conductive release layer (e.g., a second surface). In some embodiments, methods of fabricating an electrode with a conductive release layer that separates portions of the electrode from a carrier substrate (e.g., a metal foil) on which the electrode was fabricated and/or an adjacent electroactive layer are described. For example, an intermediate electrode assembly may include, in sequence, an electroactive layer, a current collector layer, a conductive release layer, and a carrier substrate. In another embodiment, an intermediate electrode assembly may include, in sequence, an electroactive layer, a conductive release layer, and a carrier substrate. In one or both of these embodiments, the carrier substrate can facilitate handling of the electrode during fabrication and/or assembly, but may be released (e.g., by the conductive release layer) from the electrode prior to commercial use and/or prior to incorporation into a final electrochemical cell.

Certain existing methods of fabricating electrodes involve depositing electrode components onto a substrate that is eventually incorporated into an electrochemical cell (e.g., a battery). The substrate must be of sufficient thickness and/or formed of a suitable material in order to be compatible with the electrode fabrication process. For example, fabrication of an electrode comprising lithium metal as an electroactive layer may involve vacuum deposition of lithium metal at relatively high temperatures and high rates that would cause certain substrates to buckle unless the substrate is made of a certain material or has a sufficient thickness. Some substrates that are suitable for such fabrication steps may, however, end up reducing the performance of the cell if the substrate is incorporated into the cell. For instance, thick substrates may prevent buckling and therefore allow the deposition of a thick layer of an electroactive layer but may reduce the specific energy density of the cell. Furthermore, certain substrates that are incorporated into the electrochemical cell may react adversely with chemical species within the electrochemical cell during cycling.

In certain existing systems and methods, an electroactive layer, such as lithium metal, could be positioned (e.g., deposited) adjacent to an additional electroactive layer with a non-conductive release layer in between the two electroactive layers and then positioned in an electrochemical cell or a battery. In such certain existing systems, the release layer is non-conductive and can act as an isolative layer between two sides of an anode, which may result in uneven distribution and utilization of the electroactive layers when utilized in the electrochemical cell or battery. As a result, during cycling of the cell, the utilization of electroactive layer (e.g., lithium) on both sides can be undesirably slightly different.

To remedy these issues, the present disclosure involves, in some aspects, methods of fabricating an electrode using a conductive release layer to separate portions of the electrode, for example, in an electrochemical cell. Advantageously, such systems and methods can allow a larger variety of substrates and/or more extreme processing conditions to be used when fabricating electrodes compared to that when a conductive release layer is not used. In addition, the use of a conductive release layer provides electronic communication between the electroactive layers (e.g., between two anodes) through the conductive release layer, which can result in more uniform current distribution and electroactive layer (e.g., lithium metal) utilization during cycling inside an electrochemical cell when compared to certain existing systems and methods that utilize a non-conductive release layer. For example, in some embodiments, a conductive release layer may be positioned in between (e.g., directly between) a first electroactive layer and a second electroactive layer such that the first and second electroactive layers are in electronic communication through the conductive release layer. In some embodiments, the first and second electroactive layers are anode layers (e.g., lithium metal layers). The conductive release layer(s) may be in direct contact with both first and second electroactive layers (e.g., lithium metal layers) in some embodiments. As just described, such an embodiment can advantageously provide more uniform current distribution and electroactive layer utilization within an electrochemical cell.

The inventors have discovered within the context of the present disclosure that systems and methods for fabricating conductive release layers may lead to suitable release layers that can be used for fabricating electrochemical cells. Conductive release layers described herein are constructed and arranged to have one or more of the following features, without limitation: relatively good adhesion to a first layer (e.g., a current collector, an electroactive layer, or in other embodiments, a carrier substrate or other layer) but relatively moderate or poor adhesion to a second layer (e.g., a carrier substrate, or in other embodiments, a current collector or other layer); relatively low electrical resistance; high mechanical stability to facilitate delamination without mechanical disintegration; high thermal stability; ability to withstand the application of a force or pressure applied to the electrochemical cell or a component of the cell during fabrication and/or during cycling of the cell; and compatibility with processing conditions (e.g., deposition of layers on top of the release layer, as well as compatibility with techniques used to form the release layer). Release layers (e.g., conductive release layers) may be thin (e.g., less than about 10 microns) to reduce overall battery weight if the conductive release layer is incorporated into the electrochemical cell. Furthermore, release layers should be stable in the electrolyte and should not interfere with the structural integrity of the electrodes in order for the electrochemical cell to have a high electrochemical “capacity” or energy storage capability (i.e., reduced capacity fade). In some cases, release layers from two electrode portions can be adhered together, optionally using an adhesion promoter as described in more detail below.

In some embodiments, conductive release layers described herein may be formed using a plurality of conductive carbon species. In contrast to certain existing release layers which primarily utilize polymers (e.g., non-conducting polymers), the conductive releases layers described herein may utilize a plurality of conductive carbon species that comprise elemental carbon, for example, carbon black and/or carbon nanotubes. The use of a plurality of conductive carbon species can impart relatively high electrical conductivity to the release layer while maintaining other desirable properties of the release layer (e.g., mechanical stability, relatively good adhesion to a first layer but relatively moderate or poor adhesion to a second layer). Additional descriptions of conductive carbon species are provided below and elsewhere herein.

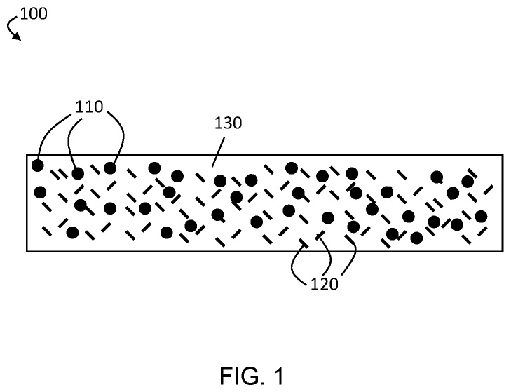

In some embodiments, a conductive release layer comprises a plurality of conductive carbon species that comprise a plurality of conductive carbon particles and a plurality of elongated carbon structures. For example, referring now to FIG. 1, a conductive release layer 100 comprises a plurality of conductive carbon particles 110 and a plurality of elongated carbon structures 120. Carbon particles 110 and elongated carbon structures 120 are dispersed throughout release layer 100.

In some embodiments, the plurality of conductive carbon species comprises elemental carbon. As will be understood by those skilled in the art, elemental carbon contains carbon at a zero oxidation state with a mixture of sp³- and sp²-hybrized carbon atoms. Elemental carbon (elemental carbon compositions) contains almost exclusively carbon atoms and hence contain a relatively high atomic percent (at %) of carbon atoms (e.g., 98 at % carbon, 99 at % carbon, 99.9 at %); however, elemental carbon can contain trace amounts (e.g., less than 2 at %, less than 1 at %, less than 0.1 at %) of other elements (e.g., hydrogen, oxygen, sulfur), for example, on the surface to terminate dangling bonds of the elemental carbon. By contrast, certain existing release layers may contain carbon-based polymers that contain much higher atomic percentages of other elements and do not comprise carbon in its elemental (e.g., zero oxidation state) form.

In some embodiments, the conductive carbon particles may provide electrical conductivity to the conductive release layer independent of the elongated carbon structures. The conductive carbon particles of the plurality of conductive carbon species may comprise a variety of suitable elemental carbon-based materials. In some embodiments, the plurality of carbon particles comprises carbon black. As understood by those skilled in the art, carbon black is a form of conductive elemental carbon characterized by substantially spherical carbon particles with a relatively high surface area to volume ratio. While substantially spherical, carbon black can form aggregates (that are substantially spherical or substantially non-spherical) in suspensions (e.g., slurries) or compositions containing the carbon black.

The conductive carbon particles can have any suitable size (e.g., average particle size). In some embodiments, the conductive carbon particles have an average particle size of less than or equal 10 microns, less than or equal 5 microns, less than or equal 1 micron, less than or equal 900 nm (nanometers), less than or equal 800 nm, less than or equal 700 nm, less than or equal 600 nm, less than or equal 500 nm, less than or equal 400 nm, less than or equal 300 nm, less than or equal 200 nm, less than or equal 100 nm, less than or equal 80 nm, less than or equal 60 nm, or less than or equal 50 nm. In some embodiments, the conductive carbon particles have an average particle size of greater than or equal to 50 nm, greater than or equal to 60 nm, greater than or equal to 80 nm, greater than or equal to 100 nm, greater than or equal to 200 nm, greater than or equal to 300 nm, greater than or equal to 400 nm, greater than or equal to 500 nm, greater than or equal to 600 nm, greater than or equal to 700 nm, greater than or equal to 800 nm, greater than or equal to 900 nm, greater than or equal to 1 micron, greater than or equal to 5 microns, or greater than or equal to 10 microns. Combinations of the above-referenced ranges are possible (e.g., greater than or equal to 50 nm and less than or equal 10 microns). Other ranges are possible. The average particle size can be measured as a cross-sectional dimension of the particle (e.g., a diameter of a conductive carbon particle) and can be measured using a variety of techniques including microscopy techniques, for example scanning tunneling microscopy (SEM) and transmission electron microscopy (TEM). One non-limiting example of conductive carbon particles with a suitable particle size is Vulcan carbon XC 72R manufactured by Cabot Corporation. However, other conductive carbon particles are possible.

In some embodiments, the plurality of conductive carbon species comprises a plurality of elongated carbon structures. As described herein, an “elongated” carbon structure is a carbon-based (e.g., an elemental carbon-based) structure in which one dimension is substantially or significantly larger (e.g., at least 2 times, at least 5 times, at least 10 times, at least 20 times, at least 50 times, at least 100 times)) than the other dimensions. Accordingly, elongated carbon structures can be characterized according to an aspect ratio of the elongated carbon structure. The aspect ratio of a structure can be calculated as the ratio of its longest side to its shortest side (e.g., the length of an elongated carbon structure to the diameter or width of the elongated carbon structure). In some embodiments, the aspect ratio of the elongated carbon structure is greater than or equal to 2:1, greater than or equal to 3:1, greater than or equal to 5:1, greater than or equal to 10:1, greater than or equal to 25:1, greater than or equal to 50:1, greater than or equal to 75:1, greater than or equal to 100:1, greater than or equal to 200:1, greater than or equal to 300:1, greater than or equal to 500:1, greater than or equal to 103:1, greater than or equal to 104:1, greater than or equal to 105:1, greater than or equal to 106:1, greater than or equal to 107:1, greater than or equal to 108:1, or greater than or equal to, 109:1. In some embodiments, the aspect ratio of the elongated carbon structure is less than or equal 109:1, less than or equal 108:1, less than or equal 107:1, less than or equal 106:1, less than or equal 105:1, less than or equal 104:1, less than or equal 103:1, less than or equal 500:1, less than or equal 300:1, less than or equal 200:1, less than or equal 100:1, less than or equal 75:1, less than or equal 50:1, less than or equal 25:1, less than or equal 10:1, less than or equal 5:1, less than or equal 3:1, or less than or equal 2:1. Combinations of the above-referenced ranges are also possible (e.g., greater than or equal to 500:1 and less than or equal 106:1). Other ranges are possible.

The plurality of elongated carbon structures can independently contribute to the electrical conductivity of the conductive release layer or may provide electrical conductivity to the conductive release layer in combination with the plurality of conductive carbon particles. Advantageously, the elongated carbon structures can also provide a degree of mechanical stability to the conductive release layer while also providing a degree of electrical conductivity to the conductive release layer.

The plurality of elongated carbon structures can comprise any suitable type of elongated carbon structure. For example, in some embodiments, the elongated carbon structures are or comprises carbon nanotubes and/or carbon fibers. In some embodiments, the elongated carbon structures comprise multi-walled carbon nanotubes. In some embodiments, the elongated carbon structures comprise elemental carbon. In some embodiments, the elongated carbon structures are substantially formed of elemental carbon.

In addition to carbon species, in some embodiments, the conductive release layer comprises other components, such as a polymeric binder. Inclusion of a polymeric binder can contribute to the mechanical stability of the conductive release layer, in addition to providing a matrix for the conductive carbon species. For example, in reference to FIG. 1, contact between carbon particles 110 and elongated carbon structures 120 may be facilitated by a polymeric binder 130. As shown illustratively in FIG. 1, carbon particles 110 and elongated carbon structures 120 may be mixed or dispersed within polymeric binder 130.

The polymeric binder can be any suitable polymer, provided that the polymer provides adequate mechanical support and/or adhesion properties to the conductive release layer. In some embodiments, the polymeric binder comprises a polysulfone polymer. However, other polymeric binders are possible. Non-limiting examples of other polymeric binders include polyether sulfone, polyether ether sulfone, polyvinyl alcohol, polyvinyl acetate, and polybenzimidazole. Additional details regarding the polymeric binder are described in more detail further below.

As described above and elsewhere herein, conductive release layers and compositions can comprise a plurality of carbon species (e.g., a plurality of conductive carbon particles, a plurality of elongated carbon structures) and a polymeric binder. It will be understood, however, that the amounts of each component can provide different properties to the conductive release layer and are selected to provide both conductivity and other desirable release layer properties (e.g., mechanical stability, adhesion strength) to the conductive release layer. For example, while a relatively high amount of polymeric binder can provide mechanical strength to the conductive release layer, too high an amount compared to the other components of the conductive release layer can undesirably reduce the electrical conductivity of the conductive release layer. Similarly, a relatively high amount of conductive carbon species (e.g., conductive carbon particles) can provide high electrical conductivity to the conductive release layer, but may result in poor mechanical strength of the conductive release layer, which can result in disintegration of the conductive release layer during cycling of a battery in which the conductive release layer is incorporated. As yet another example, if the amount of the plurality of elongated carbon structures is relatively high, it can provide mechanical strength and/or electrical conductivity to the release layer, but may result in a conductive release layer that adheres too strongly to a directly adjacent layer, such as an electroactive layer, and may therefore make it more difficult to release from the electroactive layer.

It has been recognized and appreciated within the context of the present disclosure that the relative amounts of conductive carbon species, elongated carbon species and/or polymeric binder can be tuned such that the amounts provide relatively high electrical conductivity, while still maintaining other desired properties of the conductive release layer (e.g., mechanical strength, relatively good adhesion to a first layer but relatively moderate or poor adhesion to a second layer). Examples of suitable relative amounts are described elsewhere herein. Those skilled in the art in view of the teachings of the present disclosure will be capable of selecting suitable relative amounts of conductive carbon species and polymeric binder to provide a desired conductivity and other release layer properties.

In some embodiments, the total amount of conductive carbon species (e.g., elemental carbon, conductive carbon particles, and/or elongated carbon structures) is greater than or equal to 15 wt % of the conductive release layer (e.g., the total weight of the conductive release layer). In some embodiments, the total amount of conductive carbon species is present in an amount of greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, or greater than or equal to 50 wt % of the conductive release layer (e.g., the total weight of the conductive release layer). In some embodiments, the conductive carbon species is present in an amount of less than or equal 50 wt %, less than or equal 45 wt %, less than or equal 40 wt %, less than or equal 35 wt %, less than or equal 30 wt %, less than or equal 25 wt %, less than or equal 20 wt %, or less than or equal 15 wt % of the conductive release layer (e.g., the total weight of the conductive release layer). Combinations of the above-reference ranges are also possible (e.g., greater than or equal to 15 wt % and less than or equal 50 wt % of the conductive release layer (e.g., the total weight of the conductive release layer)). Other ranges are possible.

In some embodiments, the total amount of the plurality of conductive carbon species (e.g., elemental carbon, conductive carbon particles, and/or elongated carbon structures) is greater than or equal to 15 wt % relative to the polymeric binder (e.g., the total weight of polymeric binder). In some embodiments, the total amount of the conductive carbon species is present in an amount of greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, or greater than or equal to 50 wt % of the polymeric binder (e.g., the total weight of polymeric binder). In some embodiments, the total amount of conductive carbon species is present in an amount of less than or equal 50 wt %, less than or equal 45 wt %, less than or equal 40 wt %, less than or equal 35 wt %, less than or equal 30 wt %, less than or equal 25 wt %, less than or equal to 20 wt %, or less than or equal to 15 wt % of the polymeric binder (e.g., the total weight of polymeric binder). Combinations of the above-reference ranges are also possible (e.g., greater than or equal to 15 wt % and less than or equal 50 wt % of the polymeric binder (e.g., the total weight of polymeric binder)). Other ranges are possible.

In some embodiments, a mass ratio of the total amount of conductive carbon species (e.g., elemental carbon, conductive carbon particles, and/or elongated carbon structures) to the total amount polymeric binder is greater than or equal to 1:1, greater than or equal to 1.5:1, greater than or equal to 2:1, greater than or equal to 2.5:1, or greater than or equal to 3:1. In some embodiments, the mass ratio of the total amount of conductive carbon species to the polymeric binder is less than or equal 3:1, less than or equal 2.5:1, less than or equal 2:1, less than or equal 1.5:1, or less than or equal 1:1. Combinations of the above-referenced ranges are also possible (e.g., greater than or equal to 1:1 and less than or equal 2:1). Other ranges are possible. Providing particular mass ratios of conductive carbon species to the polymeric binder can be used to help tune the conductivity of the conductive release layer while maintaining, for example, mechanical strength of the conductive release layer.

In some embodiments, a mass ratio of the total amount of conductive carbon particles to the total amount of elongated carbon structures is greater than or equal to 1:1, greater than or equal to 1.5:1, greater than or equal to 2:1, greater than or equal to 2.5:1, greater than or equal to 3:1, greater than or equal to 4:1, greater than or equal to 5:1, greater than or equal to 6:1, greater than or equal to 7:1, greater than or equal to 8:1, or greater than or equal to 9:1. In some embodiments, the mass ratio of the total amount of conductive carbon particles to the total amount elongated carbon structures is less than or equal 9:1, less than or equal 8:1, less than or equal 7:1, less than or equal 6:1, less than or equal 5:1, less than or equal 4:1, less than or equal 3:1, less than or equal 2.5:1, less than or equal 2:1, less than or equal 1.5:1, or less than or equal 1:1. Combinations of the above-referenced ranges are also possible (e.g., greater than or equal to 1:1 and less than or equal 9:1). Other ranges are possible. Providing particular mass ratios of conductive carbon particles to the elongated carbon structures can be used to help tune the conductivity of the conductive release layer while maintaining desirable adhesion properties of the conductive release layer (e.g., relatively good adhesion to a first layer but relatively moderate or poor adhesion to a second layer).

Conductive release layers described herein can have a particular electrical resistivity. The electrical resistivity of a particular conductive release layer can advantageously be tuned by selecting the appropriate mass ratio (e.g., wt %) of conductive carbon species, elongated carbon structures, and/or polymeric binder. In some embodiments, the conductive release layer has an electrical resistivity of less than or equal to 1,000 kOhm·cm, less than or equal to 500 kOhm·cm, less than or equal to 250 kOhm·cm, less than or equal to 100 kOhm·cm, less than or equal to 50 kOhm·cm, less than or equal to 25 kOhm·cm, less than or equal to 10 kOhm·cm, less than or equal to 1,000 Ohm·cm, less than or equal to 500 Ohm·cm, less than or equal to 250 Ohm·cm, less than or equal to 100 Ohm·cm, less than or equal 50 Ohm·cm, less than or equal 40 Ohm·cm, less than or equal 30 Ohm·cm, less than or equal 20 Ohm·cm, less than or equal 10 Ohm·cm, less than or equal 5 Ohm·cm, less than or equal 4 Ohm·cm, less than or equal 3 Ohm·cm, less than or equal 2 Ohm·cm, less than or equal 1 Ohm·cm, less than or equal 0.5 Ohm·cm, less than or equal 0.1 Ohm·cm, less than or equal 0.01 Ohm·cm, less than or equal to 0.005 Ohm·cm, less than or equal to 0.004 Ohm·cm, less than or equal to equal to 0.003 Ohm·cm, less than or equal to 0.002 Ohm·cm, or less than or equal to 0.001 Ohm·cm. In some embodiments, the conductive release layer has an electrical resistivity of greater than or equal to 0.001 Ohm·cm, greater than or equal to 0.002 Ohm·cm, greater than or equal to 0.003 Ohm·cm, greater than or equal to 0.004 Ohm·cm, greater than or equal to 0.005 Ohm·cm, greater than or equal to 0.01 Ohm·cm, greater than or equal to 0.05 Ohm·cm, greater than or equal to 0.1 Ohm·cm, greater than or equal to 0.5 Ohm·cm, greater than or equal to 1 Ohm·cm, greater than or equal to 2 Ohm·cm, greater than or equal to 3 Ohm·cm, greater than or equal to 4 Ohm·cm, greater than or equal to 5 Ohm·cm, greater than or equal to 10 Ohm·cm, greater than or equal to 20 Ohm·cm, greater than or equal to 30 Ohm·cm, greater than or equal to 40 Ohm·cm, greater than or equal to 50 Ohm·cm, greater than or equal to 100 Ohm·cm, greater than or equal to 250 Ohm·cm, greater than or equal to 500 Ohm·cm, greater than or equal to 1,000 Ohm·cm, greater than or equal to 10 kOhm·cm, greater than or equal to 25 kOhm·cm, greater than or equal to 50 kOhm·cm, greater than or equal to 100 kOhm·cm, greater than or equal to 250 kOhm·cm, greater than or equal to 500 kOhm·cm, or greater than or equal to 1,000 kOhm·cm. Combinations of the above-referenced ranges are also possible (e.g., greater than or equal to 0.001 Ohm·cm and less than or equal to 1000 kOhm·cm). Other resistivities are possible. The electrical resistivity can be measured, for example, by using a four-point probe to measure the resistance, surface resistivity, and/or volume resistivity, which can also be used to determine the electrical conductivity.

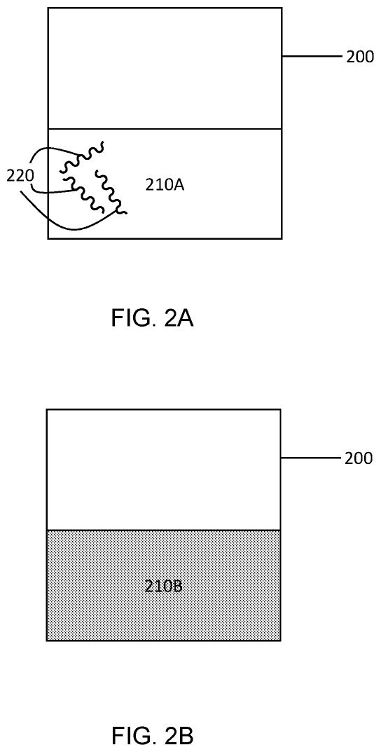

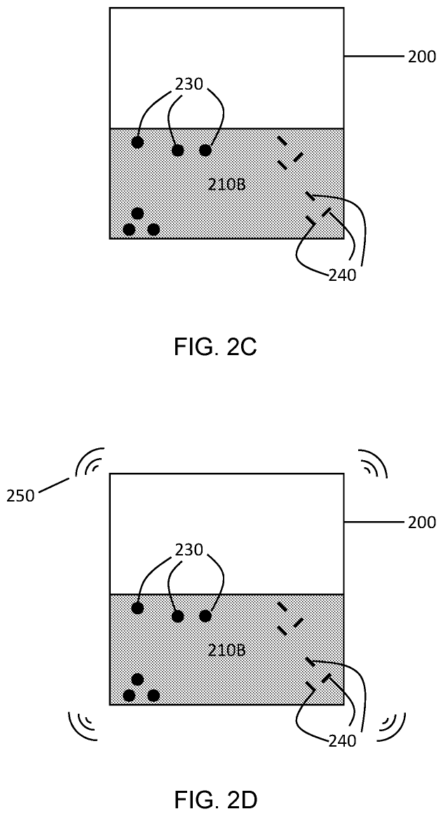

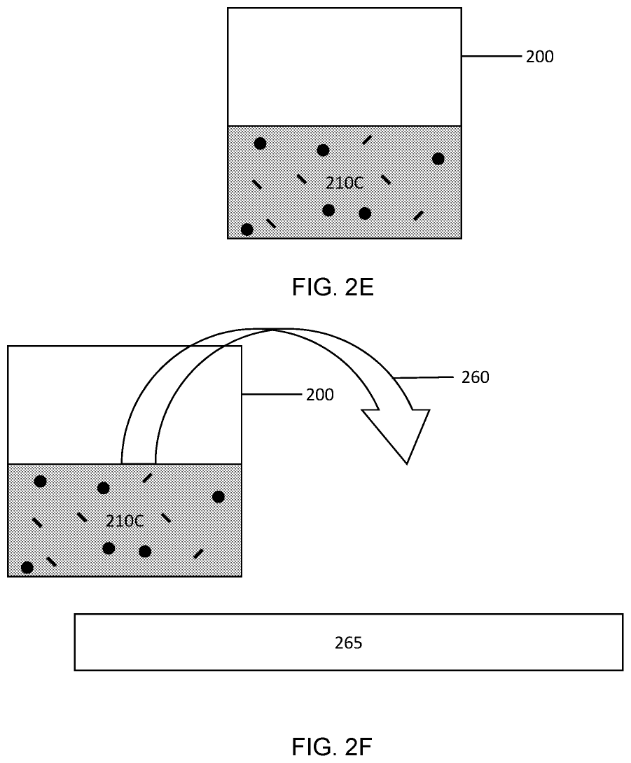

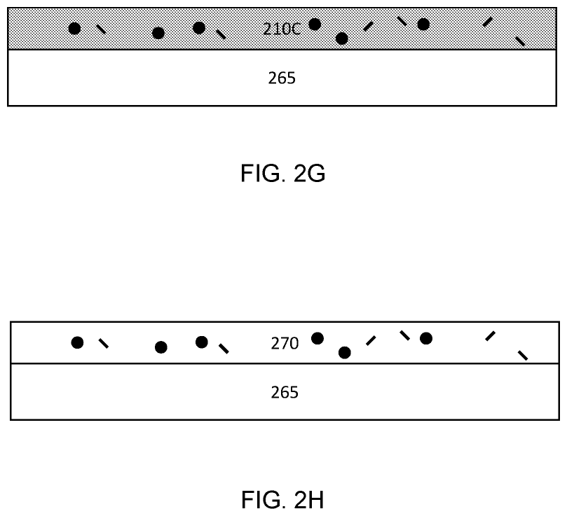

In some embodiments, a method of forming a conductive release layer is provided. The method can comprise dissolving a polymeric binder in a solvent to form a solution. For example, in reference to FIG. 2A, container 200 contains solvent 210A and polymeric binders 220. Solvent 210A can dissolve polymeric binders 220 to form a solution 210B, shown illustratively in FIG. 2B.

The method can comprise adding a plurality of conductive carbon species to the solution to form a slurry. For example, in FIG. 2C, conductive carbon particles 230 and elongated carbon structures 240 have been added to solution 210B. Conductive carbon particles 230 and elongated carbon structures 240 can be dispersed or mixed in solution 210B via dispersion 250, schematically illustrated in FIG. 2D. Upon dispersing, a suspension of conductive particles 230 and elongated carbon structures 240 is formed, shown illustratively in FIG. 2E as slurry 210C. Techniques for dispersing the plurality of conductive carbon species are described elsewhere herein.

The method can also comprise evaporating at least a portion of the solvent from the slurry to form the release layer (e.g., the conductive release layer). Referring to FIG. 2F, slurry 210C can be deposited via deposition 260 onto a substrate 265 (e.g., a carrier substrate, an electroactive layer, a current collector) such that it forms a layer adjacent to substrate 265, as shown illustratively in FIG. 2G. In some embodiments, the slurry forms a coating on the substrate. Substantially all or a portion of the solvent can be evaporated from slurry 210C to form a conductive release layer 270, as schematically illustrated in FIG. 2H.

In some embodiments, a current collector or an electroactive layer is deposited on the release layer. For example, in reference to FIG. 2I, an electroactive layer 275 is deposited on conductive release layer 270, although, in other embodiments, a current collector is deposited on conductive release layer 270 (not shown). In some embodiments, the release layer is directly adjacent to the electroactive layer, as schematically illustrated in FIG. 2I.

While FIG. 2I shows one electroactive layer (electroactive layer 275) adjacent to the release layer (conductive release layer 270), it should be understood that one or more additional layers can be deposited adjacent (e.g., above) the release layer, such as additional electroactive layers, release layers (e.g., additional conductive layers), current collectors, and/or other components described elsewhere herein. For example, in some embodiments, a current collector is positioned adjacent the electroactive layer and the release layer (e.g., the conductive release layer).

The conductive release layers described herein may be used for forming lithium-based rechargeable electrochemical cells (i.e., cells including a lithium intercalation cathode and a lithium anode). A variety of active materials are suitable for use with second electroactive layers (e.g., cathodes) of the electrochemical cells described herein, according to various embodiments. In some embodiments, the active material comprises a lithium intercalation compound (e.g., a compound that is capable of reversibly inserting lithium ions at lattice sites and/or interstitial sites). In some cases, the active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In some embodiments, the active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In some cases, the electroactive layer of the second electroactive layer (e.g., cathode) comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

Examples of release layers (e.g., conductive release layers) used in fabricating electrochemical cells are now provided.

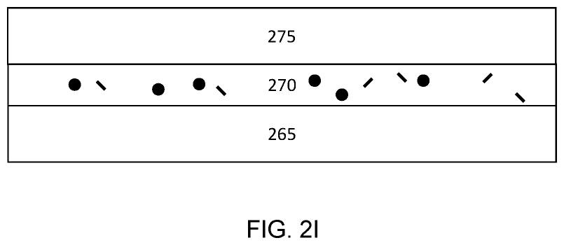

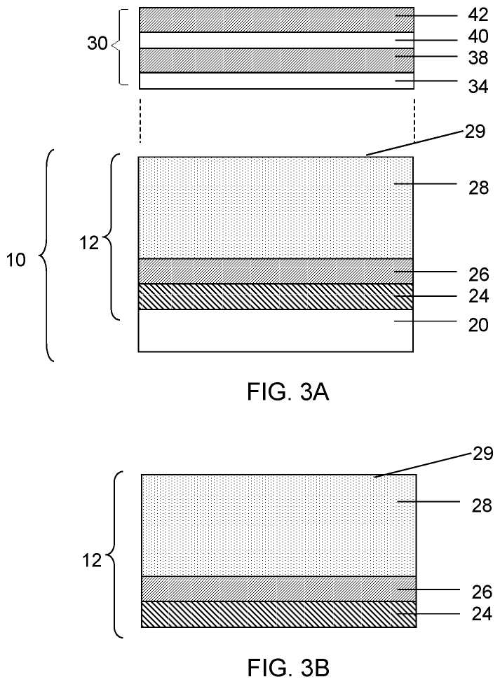

FIG. 3A shows an electrode assembly that includes a conductive release layer according to one embodiment. As shown in the illustrative embodiment of FIG. 3A, electrode assembly 10 includes several layers that are stacked together to form an electrode 12 (e.g., an anode or a cathode; a first electrode or a second electrode). Electrode 12 can be formed by positioning the layers on a carrier substrate 20. For example, electrode 12 may be formed by first positioning one or more conductive release layers 24 on a surface of carrier substrate 20. As described in more detail below, the conductive release layer serves to subsequently release the electrode from the carrier substrate so that the carrier substrate is not incorporated into the final electrochemical cell. To form the electrode, an electrode component such as an optional current collector 26 can be positioned adjacent the conductive release layer on the side opposite the carrier substrate. Subsequently, an electroactive layer 28 may be positioned adjacent current collector 26. In embodiments in which the current collector is not present, the conductive release layer may be positioned directly adjacent the electroactive layer (e.g., directly adjacent both the electroactive layer and the carrier substrate).

Optionally, additional layers can be positioned adjacent electroactive layer 28. For example, a multi-layered structure 30 that protects the electroactive layer from an electrolyte, may be positioned on a surface 29 of electroactive layer 28. The multi-layer structure can include, for example, polymer layers 34 and 40, and single-ion conductive layers 38 and 42. Other examples and configurations of multi-layer structures are described in more detail in U.S. patent application Ser. No. 11/400,781, filed Apr. 6, 2006, entitled, “Rechargeable Lithium/Water, Lithium/Air Batteries” to Affinito et al., which is incorporated herein by reference in its entirety.

After electrode assembly 10 has been formed, the carrier substrate 20 may be released from the electrode through the use of conductive release layer 24. Conductive release layer 24 can be released along with the carrier substrate so that the conductive release layer may remain a part of the final electrode structure as shown illustratively in FIG. 3B. The positioning of the conductive release layer during release of the carrier substrate can be varied by tailoring the chemical and/or physical properties of the conductive release layer. For example, if it is desirable for the conductive release layer to be part of the final electrode structure, as shown in FIG. 3B, the conductive release layer may be tailored to have a greater adhesive affinity to current collector 26 relative to its adhesive affinity to carrier substrate 20.

In some embodiments, carrier substrate 20 is left intact with electrode 12 as a part of electrode assembly 10 after fabrication of the electrode, but before the electrode is incorporated into an electrochemical cell. For instance, electrode assembly 10 may be packaged and shipped to a manufacturer who may then incorporate electrode 12 into an electrochemical cell. In such embodiments, electrode assembly 10 may be inserted into an air and/or moisture-tight package to prevent or inhibit deterioration and/or contamination of one or more components of the electrode assembly. Allowing carrier substrate 20 to remain attached to electrode 12 can facilitate handling and transportation of the electrode. For instance, carrier substrate 20 may be relatively thick and have a relatively high rigidity or stiffness, which can prevent or inhibit electrode 12 from distorting during handling. In such embodiments, carrier substrate can be removed by the manufacturer before, during, or after assembly of an electrochemical cell.

Although FIG. 3A shows conductive release layer 24 positioned between carrier substrate 20 and current collector 26, in other embodiments conductive the release layer may be positioned between other components of an electrode. For example, the conductive release layer may be positioned adjacent surface 29 of electroactive layer 28, and the carrier substrate may be positioned on the opposite side of the electroactive layer (not shown). In some such embodiments, an electrode may be fabricated by first positioning one or more conductive release layers onto a carrier substrate. Then, if any protective layer(s) such as multi-layered structure 30 is to be included, the protective layer(s) can be positioned on the one or more conductive release layers. For example, each layer of a multi-layered structure may be positioned separately onto a conductive release layer, or the multi-layered structure may be prefabricated and positioned on a conductive release layer at once. The electroactive layer may then be positioned on the multi-layered structure. (Of course, if a protective layer such as a multi-layered structure is not included in the electrode, the electroactive layer can be positioned directly on the conductive release layer.) Afterwards, any other suitable layers such as a current collector may be positioned on the electroactive layer. To form the electrode, the carrier substrate can be removed from the protective layer(s) (or the electroactive layer where protective layers are not used) via the conductive release layer. The conductive release layer may remain with the electrode.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

It should be understood, therefore, that in the embodiments illustrated in FIGS. 3A and 3B and in other embodiments described herein, one or more additional layers may be positioned between the layers shown in the figures. For example, one or more additional layers may be positioned between current collector 26 and conductive release layer 24, and/or one or more additional layers may be positioned between release layer 24 and carrier substrate 20. Furthermore, one or more layers may be positioned between other components of the cell. For example, one or more primer layers can be positioned between a current collector and an electroactive layer (e.g., a positive or negative electroactive layer) to facilitate adhesion between the layers. Examples of suitable primer layers are described in International Patent Application Serial No. PCT/US2008/012042, published as International Publication No. WO 2009/054987, filed Oct. 23, 2008, and entitled “Primer For Battery Electrode”, which is incorporated herein by reference in its entirety. Furthermore, one or more layers such as plasma treatment layers may be deposited on surface 29 of electroactive layer 28, optionally between the electroactive layer and multi-layer structure 30.

In other embodiments, however, more than one release layer (e.g., conductive release layers) is used to fabricate a component of an electrochemical cell. The additional release layers (e.g., a second conductive release layer) may have the same or different properties of the first conductive release layer. For instance, a first conductive release layer may be positioned adjacent a carrier substrate and may have, for example, a relatively high adhesive affinity to the carrier substrate. The first conductive release layer may be chosen because it is compatible with certain processing conditions, but it may have a relatively high adhesive affinity to a second surface (e.g., current collector 26 of FIG. 3A). In such embodiments, the conductive release layer would not allow release of the carrier substrate. Thus, a second release layer may be positioned between the first conductive release layer and the second surface to allow adequate release of the carrier substrate. In one embodiment, the second release layer has a relatively high adhesive affinity to the first conductive release layer, but a relatively low adhesive affinity to the second surface. As such, the application of a force could allow removal of the carrier substrate and both release layers from the second surface. In another embodiment, the second release layer has a relatively low adhesive affinity to the first conductive release layer and relatively high adhesive affinity to the second surface. In such embodiments, the application of a force could allow removal of the carrier substrate and the first conductive release layer, which the second release layer and the second surface remain intact. Other configurations of release layers are also possible.

In some embodiments, a conductive release layer has one or more functions once incorporated into an electrochemical cell. For example, the release layer may act as a separator, an electroactive layer, or a protective layer for an electroactive layer, may contribute to the mechanical stability of the electrochemical cell, and/or may facilitate the conduction of ions and/or electrons across the release layer.

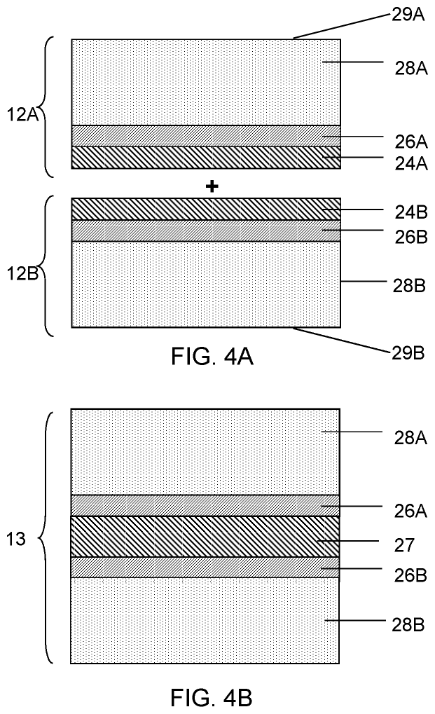

In some particular embodiments, a conductive release layer has an adhesive function of allowing two components of an electrochemical cell to adhere to one another. One such example is shown in the embodiments illustrated in FIGS. 4A and 4B. As shown illustratively in FIG. 4A, a first electrode portion 12A may include one or more release layers 24A (e.g., one or more conductive release layers), a current collector 26A, and an electroactive layer 28A. Such an electrode portion may be formed after being released from a carrier substrate, e.g., using the method described above in connection with FIGS. 4A and 4B. Similarly, a second electrode portion 12B may include a release layer 24B, a current collector 26B, and an electroactive layer 28B. Additional layers can also be deposited onto surfaces 29A and/or 29B of electrode portions 12A and 12B respectively, as described above.

As shown in the embodiment illustrated in FIG. 4B, a back-to-back electrode assembly 13 may be formed by joining electrode portions 12A and 12B, e.g., via release layers 24A and 24B. The electrode portions may be separate, independent units or part of the same unit (e.g., folded over). As illustrated in FIG. 4B, release layers 24A and 24B are facing one another. In other embodiments, however, the electrode portions can be stacked upon one another in series such that release layers 24A and 24B do not face one another in the final configuration.

Any suitable method may be used to join two components of an electrochemical cell via one or more release layers (e.g., one or more conductive release layers). In some embodiments, release layers 24A and 24B are formed of one or more materials that naturally have a relatively high adhesive affinity to each other, e.g., either inherently or after being activated. In some embodiments, an adhesion promoter may be used to facilitate adhesion of two components. For example, the materials used to form the release layers may be joined by applying an external stimulus such as heat and/or light to activate a surface of a release layer to make it more adhesive. In other embodiments, an adhesion promoter in the form of a chemical such as a crosslinker can be applied to a surface of a release layer to facilitate joining with another layer. Adhesion promoters in the form of solvents and/or adhesives can also be used, as described in more detail below. In yet other embodiments, a release layer may inherently have a high adhesive affinity to a material in which it is to be joined and no adhesion promoter is needed. Pressure may optionally be applied during the joining of two components.

In some embodiments, two components of an electrochemical cell such as electrode portions 12A and 12B of FIG. 4A are joined with one another, e.g., via a lamination process. A lamination process may involve, for example, applying an adhesion promoter such as a solvent (optionally containing other materials) to a surface of release layers 24A and/or 24B and solvating at least a portion of the release layer(s) to make the release layers more susceptible to adhesion. The release layers can then be brought together to join the release layers. After joining (or, in some embodiments, prior to joining), the solvent can be optionally removed, e.g., by a drying process. In some such embodiments, e.g., when release layers 24A and 24B are formed of the same material, the joining of the release layers can result in a single layer 27, as shown in the embodiment illustrated in FIG. 4B. For instance, where release layers 24A and 24B are formed of a polymeric material, the joining of the release layers (e.g., after solvation) can cause polymer chains at the surface of one release layer to intertwine with polymer chains at the second release layer. In some cases, intertwining of the polymer chains can occur without the application of additional chemicals and/or conditions (e.g., without the use of an adhesion promoter). In other embodiments, intertwining of polymer chain can be facilitated by subjecting the polymer to certain conditions such as cross linking or melting, as described in more detail below. In such an embodiment, when layer 27 is a conductive release layer, electroactive layer 28A and 28B are in electronic communication through layer 27.

When first and second release layers are joined together (optionally using an adhesion promoter), the adhesive strength between the two release layers may be greater than the adhesive strength between the first release layer and a layer opposite the second release layer (e.g., between the first release layer and a current collector). In other embodiments, the adhesive strength between the two release layers may be less than the adhesive strength between the first release layer and a layer opposite the second release layer (e.g., between the first release layer and the current collector). Adhesive strengths can be determined by those of ordinary skill in the art in combination with the description provided herein.

As described herein, in some embodiments, lamination may involve applying an adhesion promoter (e.g., in the form of an adhesive or a solvent combination) to a surface of a release layer prior to joining of the two electrodes. For instance, an adhesive (e.g., a polymer or any other suitable material) may be added to a solvent or solvent combination to form an adhesion promoter formulation, which is then applied uniformly to a surface of release layer 24A (and/or 24B). When applying an adhesion promoter to the release layer(s), the adhesion promoter may be applied to only one of the release layers, or to both release layers. The two surfaces to be adhered can then be joined, optionally followed by the application of heat, pressure, light, or other suitable condition to facilitate adhesion.

As described in more detail below, an adhesion promoter may form a discrete layer at the interface between the two release layers to be joined (or between any two components to be joined). The layer of adhesion promoter may, in some cases, be very thin (e.g., between 0.001 and 3 microns thick), as described in more detail below. Advantageously, using a thin layer of adhesion promoter can increase the specific energy density of the cell compared to using a thicker layer of adhesion promoter.

In other embodiments, an adhesion promoter does not form a discrete layer at the interface between the two release layers. In some such embodiments, the adhesion promoter is a solvent or solvent combination that wets the surface(s) of the release layer(s) and does not include a polymer and/or any other non-solvent material. The solvent in the adhesion promoter may solvate, dissolve, and/or activate portions of the release layer surface to promote adhesion of the release layer with another release layer.

In other embodiments in which an adhesion promoter does not form a discrete layer at the interface between the two release layers, the adhesion promoter formulation may include a solvent or solvent combination that wets the surface(s) of the release layer(s) along with a polymer in relatively small amounts (e.g., less than 5%, less than 4%, less than 3%, less than 2%, or less than 1% by weight of the adhesion promoter formulation).

In some cases in which the adhesion promoter includes a polymer (or any other non-solvent material) in its formulation, the type, amount, and molecular weight of the polymer (or other non-solvent material) may be chosen such that a discrete layer is not formed at the interface between two release layers. For instance, even though the adhesion promoter may be applied to the surface of the release layer in the form of a layer or a coating, after joining the release layers, the polymer or other non-solvent material in the adhesion promoter formulation may migrate into the pores or interstices of the release layer(s) or be miscible with the release layer(s) such that a discrete layer of adhesion promoter is not formed. In other embodiments, the polymer or non-solvent material of the adhesion promoter formulation may join with polymer chains of the release layer(s) (e.g., a polymeric binder of the conductive release layer), and the joined polymer chains may rearrange within the release layer(s) such that a discrete layer of adhesion promoter is not formed. In some cases, such rearrangement and/or migration causes at least a portion of the adhesion promoter to be interspersed (e.g., uniformly or non-uniformly) in the first and/or second release layers. In some embodiments, a substantial portion (e.g., substantially all) of the adhesion promoter is interspersed (e.g., uniformly or non-uniformly) in the first and/or second release layers. In some embodiments, such rearrangement and/or migration occurs upon assembly of the electrode or electrochemical cell. In other embodiments, such rearrangement and/or migration occurs during cycling of the electrochemical cell.

After assembly of the electrode and/or cell, all or portions of the adhesion promoter may be positioned between first and second electroactive layers (e.g., electroactive anode layer), between first and second current collectors, between first and second release layers, interspersed in first and/or second release layers, interspersed in a single release layer, or combinations thereof.

Further description of adhesion promoters are described in more detail below.

Although FIG. 4B shows a single layer 27 formed by the joining of two release layers 24A and 24B of FIG. 4A, it should be understood that other configurations are also possible. For instance, in some cases release layers 24A and 24B are formed of different materials so that the joining of the two release layers results in two different intermediate layers. In yet other embodiments, only one component of an electrochemical cell to be joined includes a release layer, but a second component to be joined does not include a release layer. For example, electrode portion 12A of FIG. 4A may include release layer 24A, but a second electrode portion to be joined with electrode portion 12A does not include a release layer. In some such embodiments, release layer 24A may also have sufficient adhesive characteristics that allow it to be joined directly to a component the second electrode. Such a release layer may be designed to not only have a high adhesive affinity to a surface of the first electrode portion (e.g., currently collector 26A) and a relatively low adhesive affinity to a carrier substrate on which the first electrode portion was fabricated, but also a relatively high adhesive affinity to a surface of the second electrode portion. In other embodiments, an adhesion promoter that has a high adhesive affinity to both the release layer and the second electrode portion can be used. Suitable screening tests for choosing appropriate materials to be used as release layers and/or adhesion promoters are described in more detail below.

In some embodiments, an electrode assembly including laminated back-to-back electrode portions (e.g., at least two electroactive layers separated by a layer, such as a conductive release layer described herein, and optionally other components), includes a conductive release layer having a relatively low overall thickness. The release layer in this configuration may be a single layer or a combined layer (e.g., two layers adhered together using an adhesion promoter) formed from the same or different materials as described herein (e.g., layer 27 of FIG. 4B). The total thickness of the release layer in this configuration may be, for example, between 1-10 microns thick, between 1-7 microns thick, between 1-6 microns thick, between 1-5 microns thick, or between 1-3 microns thick. In some embodiments, the thickness of the release layer in this configuration is about 10 microns or less, about 8 microns or less, about 6 microns or less, about 7 microns or less, about 5 microns or less, or about 3 microns or less.

It should be understood that while FIGS. 4A and 4B show the joining of two electrode portions via release layers 24A and/or 24B, in other embodiments the methods and articles described herein can be used to join an electrode portion with a different component of an electrochemical cell, such as a solid separator and/or a protective layer. Furthermore, while FIGS. 3 and 4 show the use of one or more release layers for forming an electrode, the methods and articles described herein can also be used to fabricate other components of a cell such as a separator and/or a protective layer.

A conductive release layer to be used in fabricating components of an electrochemical cell may be formed of any suitable material and will depend, at least in part, on factors such as the particular type of carrier substrate used, the material in contact with the other side of the release layer, whether the release layer is to be incorporated into the final electrochemical cell, and whether the release layer has an additional function after being incorporated into the electrochemical cell. Other factors are possible. Furthermore, a conductive release layer may be formed of a suitable material allowing it to have a relatively high adhesive affinity to a first layer (e.g., a current collector, or in other embodiments, an electroactive layer or other layer) but a relatively moderate or poor adhesive affinity to a second layer (e.g., a carrier substrate, or in other embodiments, a current collector or other layer). The conductive release layer may also have a high mechanical stability to facilitate delamination without mechanical disintegration and/or a high thermal stability. The material properties of the conductive release layer should also be compatible with certain processing conditions. If the conductive release layer is incorporated into a final electrochemical cell, the conductive release layer should be formed of a material that is stable in the electrolyte and should not interfere with the structural integrity of the electrodes in order for the electrochemical cell to have a high electrochemical “capacity” or energy storage capability (i.e., reduced capacity fade).

Moreover, in some embodiments a conductive release layer used to form a component of an electrochemical cell is designed to withstand the application of a force or pressure applied to the component during fabrication and/or during cycling of the cell. For example, a conductive release layer described herein may be compatible with the methods and articles described in U.S. patent application Ser. No. 12/535,328, filed Aug. 4, 2009, published as U.S. Publication No. 2010/0035128, and entitled “Application of Force In Electrochemical Cells”, which is incorporated herein by reference in its entirety for all purposes.

Release layers (e.g., conductive release layers) described herein may comprise a particular RMS surface roughness. For example, a particular surface roughness (e.g., a relatively low surface roughness) may provide better contact between conductive release layers during relamination. In some embodiments, the release layer comprises an RMS surface roughness of greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 4.5 microns, or greater than or equal to 5 microns. In some embodiments, the release layer comprises an RMS surface roughness of less than or equal 5 microns, less than or equal 4.5 microns, less than or equal 4 microns, less than or equal 4 microns, less than or equal 3.5 microns, less than or equal 3 microns, less than or equal 2.5 microns, less than or equal 2 microns, less than or equal 1.5 microns or less than or equal 1 micron. Combinations of the above-referenced ranges are also possible (e.g., greater than or equal to 1 micron and less than or equal 5 microns). Other ranges are possible.

In some embodiments, a release layer (e.g., a conductive release layer) is adjacent to or formed on a substrate, such as a metal foil. For example, a slurry comprising conductive carbon species can be deposited on a metal foil and the solvent can be at least partially evaporated to form the conductive release layer adjacent (e.g., directly adjacent) to the metal foil. In some embodiments, the metal foil comprises aluminum, nickel, copper, and/or iron. However, the metal foil can comprise other metals. Examples of other metals include, but are not limited to, silver, gold, zinc, magnesium, and/or molybdenum. Other metals are also possible. Those skilled in the art based on the teachings of the present disclosure will be capable of selecting an appropriate metal for the metal foil for a particular application. In some embodiments, lithium metal can be deposited directly onto the release layer attached to the metal foil. The metal foil may provide for a relative increase in thermal conductivity when compared to when a polymer substrate is used and can advantageously increase the rate of lithium deposition when lithium is deposited to form the electroactive layer.

As described herein, the adhesion promoter may include a formulation that can solvate, dissolve portions of, and/or activate a surface of a release layer (e.g., a conductive release layer) to which the adhesion promoter formulation comes in contact to promote adhesion between the release layer and another component of the cell. In some embodiments, the adhesion promoter is relatively inert with respect to other components of the cell (e.g., current collector, electroactive layer, electrolyte). In some embodiments, the adhesion promoter may be formulated or applied (e.g., in a certain amount or by a particular method) such that penetration of the adhesion promoter through the release layer is minimized so that the adhesion promoter does not react with one or more components of the cell. The particular adhesion promoter formulation may be designed such that it can be easily applied to a component of the cell, e.g., by techniques such as coating, spraying painting, and other methods described herein and known to those of ordinary skill in the art.

In some embodiments, an adhesion promoter (e.g., an adhesive or a solvent solution) may include one or more of the materials that can be used to form the release layer (e.g., the conductive release layer). Typically, the adhesion promoter has a different formulation than that of the release layer; however, in some embodiments, the formulations may be substantially similar.

The release layer (e.g., the conductive release layer) and/or an adhesion promoter may be formed of or include in its composition, for example, a metal, a ceramic, a polymer, or a combination thereof.

In some embodiments, a release layer (e.g., a conductive release layer) and/or an adhesion promoter comprises a polymeric material (e.g., a polymeric binder). In some cases, at least a portion of the polymeric material of the release layer and/or an adhesion promoter is crosslinked; in other cases, the polymeric material(s) is substantially uncrosslinked. When included in an adhesion promoter formulation, a polymer may act as an adhesive to promote adhesion between two components of an electrochemical cell.

At least a portion of a polymer is crosslinked when there are crosslinking bonds connecting two or more individual polymer chains to one another through at least one position not at a terminal end of one of the polymer chains. For instance, in cases in which a primer layer comprises a certain percentage by weight of a crosslinked polymeric material, that percentage by weight of the individual polymer chains within that layer may be linked to at least one intermediate (e.g., non-terminal) position along the polymer chain with another polymer chain within that layer. In some embodiments, crosslinking bonds are covalent bonds. In other embodiments, crosslinking bonds are ionic bonds. Together, crosslinked polymer chains create interconnected, three-dimensional polymer networks. Crosslinking bonds attaching independent polymer chains to one another may be generated by methods such as UV radiation, gamma-radiation, crosslinking agents, thermal stimulation, photochemical stimulation, electron beams, self-crosslinking, free radicals, and other methods known to one of ordinary skill in the art.

In some cases, a release layer (e.g., a conductive release layer) and/or an adhesion promoter comprises less than 30% by weight of a crosslinked polymeric material (e.g., as determined after the primer layer has been dried). That is, less than 30% by weight of the individual polymer chains which form the polymeric material of a particular layer may be crosslinked at at least one intermediate (e.g., non-terminal) position along the chain with another individual polymer chain within that layer. A release layer and/or an adhesion promoter may include, for example, less than 25% by weight, less than 20% by weight, less than 15% by weight, less than 10% by weight, less than 5% by weight, or less than 2% by weight, or 0% of a crosslinked polymeric material. In some embodiments, a release layer and/or an adhesion promoter includes less than 30% by weight of a covalently crosslinked polymeric material. For example, a release layer and/or an adhesion promoter may include less than 25% by weight, less than 20% by weight, less than 15% by weight, less than 10% by weight, less than 5% by weight, or less than 2% by weight, or 0% of a covalently crosslinked polymeric material. In one particular embodiment, a release layer and/or an adhesion promoter is essentially free of covalently crosslinked material.

Sometimes, a release layer (e.g., a conductive release layer) has a different degree of crosslinking within the layer. For instance, a first surface of a release layer may include a lesser amount of a crosslinked polymer, and a second surface of the release layer may include higher amounts of crosslinked polymer. The amount of crosslinking may be in the form a gradient within the layer. Other arrangements are also possible.

In some embodiments, a release layer (e.g., a conductive release layer) and/or an adhesion promoter comprises a substantially uncrosslinked polymeric material. As used herein, the term “substantially uncrosslinked” means that during normal processing of the polymeric material to form a release layer, an adhesion promoter, and/or to fabricate an electrochemical cell associated therewith, methods commonly known for inducing crosslinking in the polymeric material, such as exposure to ultraviolet (UV) radiation and addition of crosslinking agents, are not used. A substantially uncrosslinked material may be essentially free of crosslinked material to the extent that it has no greater degree of crosslinking than is inherent to the polymeric material. In some embodiments, a substantially uncrosslinked material is essentially free of crosslinked material to the extent that it has no greater degree of crosslinking than is inherent to the polymeric material after normal processing of the polymeric material to form the release layer, an adhesion promoter, and/or to fabricate an electrochemical cell associated therewith. Typically, a substantially uncrosslinked material has less than 10% by weight, less than 7% by weight, less than 5% by weight, less than 2% by weight, or less than 1% by weight of crosslinked polymeric material in its composition. In some embodiments, a substantially uncrosslinked material has less than 10% by weight, less than 7% by weight, less than 5% by weight, less than 2% by weight, or less than 1% by weight of covalently crosslinked polymeric material in its composition.

Polymeric material (e.g., polymeric binder) may be crosslinked to varying degrees depending on the number of chains involved in at least one crosslinking bond. The percent by weight of crosslinked polymer out of a total mass of polymeric material may be determined by identifying the mass of polymers engaged in crosslinking bonds relative to the whole mass under consideration. Such a determination may be achieved by one of ordinary skill in the art by a variety of scientific methods including, for example, FTIR and differential scanning calorimetry (DCS).

It should be understood that while a release layer (e.g., conductive release layers) and/or an adhesion promoter may include a certain percentage of crosslinked polymeric material (e.g., less than 30% by weight of a crosslinked polymeric material), the total amount of polymeric material (e.g., combined crosslinked and non-crosslinked polymeric material) in the release layer and/or adhesion promoter may vary, e.g., from 20-100% by weight of the release layer and/or adhesion promoter (e.g., from 30-90 wt %, from 50-95 wt %, or from 70-100 wt %). The remaining material used to form the release layer and/or adhesion promoter may include, for example, a filler (e.g., conductive, semi-conductive, or insulating filler), a crosslinking agent, a surfactant, one or more solvents, other materials as described herein, and combinations thereof.

In some embodiments, a release layer (e.g., a conductive release layer) and/or an adhesion promoter includes a UV curable material. For instance, greater than or equal to 30 wt %, greater than or equal to 50 wt %, or greater than or equal to 80 wt % of a release layer or a layer formed by an adhesion promoter may be a UV curable material. In other instances, greater than or equal to 30 wt %, greater than or equal to 50 wt %, or greater than or equal to 80 wt % of a release layer or a layer formed by an adhesion promoter is a non-UV curable material. In one embodiment, substantially all of a release layer and/or a layer formed by an adhesion promoter is non-UV curable.

In some embodiments, a release layer (e.g., a conductive release layer) and/or an adhesion promoter described herein comprises a material including pendant hydroxyl functional groups. Hydroxyl groups may provide the release layer with a relatively high adhesive affinity to a first layer but a relatively moderate or poor adhesive affinity to a second layer, or may allow an adhesion promoter to facilitate adhesion between a release layer and another component (e.g., between two release layers). Non-limiting examples of hydroxyl-containing polymers include poly vinyl alcohol (PVOH), polyvinyl butyral, polyvinyl formal, vinyl acetate-vinyl alcohol copolymers, ethylene-vinyl alcohol copolymers, and vinyl alcohol-methyl methacrylate copolymers. The hydroxyl-containing polymer may have varying levels of hydrolysis (thereby including varying amounts of hydroxyl groups). For instance, a polymer (e.g., a vinyl-based polymer) may be greater than 50% hydrolyzed, greater than 60% hydrolyzed, greater than 70% hydrolyzed, greater than 80% hydrolyzed, greater than 90% hydrolyzed, greater than 95% hydrolyzed, or greater than 99% hydrolyzed. A greater degree of hydrolysis may allow, for example, better adhesion of the hydroxyl-containing material to certain materials and, in some cases, may cause the polymer to be less soluble in the electrolyte. In other embodiments, a polymer having hydroxyl groups may be less than 50% hydrolyzed, less than 40% hydrolyzed, less than 30% hydrolyzed, less than 20% hydrolyzed, or less than 10% hydrolyzed with hydroxyl functional groups. In some cases, a release layer and/or an adhesion promoter is water soluble.

In some embodiments, a release layer and/or an adhesion promoter described herein comprises polyvinyl alcohol. The polyvinyl alcohol in a release layer and/or an adhesion promoter may be crosslinked in some instances, and substantially uncrosslinked in other instances. In one particular embodiment, a release layer immediately adjacent a carrier substrate comprises polyvinyl alcohol. In another embodiment, the release layer consists essentially of polyvinyl alcohol. The polyvinyl alcohol in such and other embodiments may be substantially uncrosslinked, or in other cases, less than 30% of the material used to form the first release layer is crosslinked. For instance, a release layer immediately adjacent a carrier substrate and including polyvinyl alcohol may comprise less than 30% by weight, less than 20% by weight, less than 15% by weight, less than 10% by weight, less than 5% by weight, or less than 2% by weight, of crosslinked polyvinyl alcohol. Such a release layer may optionally be adjacent a second release layer, which may have a different material composition than that of the first release layer.

Certain types of polymers (e.g., polymeric binders) are known to form crosslinking bonds under appropriate conditions. Non-limiting examples of crosslinkable polymers include: polyvinyl alcohol, polyvinylbutryl, polyvinylpyridyl, polyvinyl pyrrolidone, polyvinyl acetate, acrylonitrile butadiene styrene (ABS), ethylene-propylene rubbers (EPDM), EPR, chlorinated polyethylene (CPE), ethelynebisacrylamide (EBA), acrylates (e.g., alkyl acrylates, glycol acrylates, polyglycol acrylates, ethylene ethyl acrylate (EEA)), hydrogenated nitrile butadiene rubber (HNBR), natural rubber, nitrile butadiene rubber (NBR), certain fluoropolymers, silicone rubber, polyisoprene, ethylene vinyl acetate (EVA), chlorosulfonyl rubber, fluorinated poly(arylene ether) (FPAE), polyether ketones, polysulfones, polyether imides, diepoxides, diisocyanates, diisothiocyanates, formaldehyde resins, amino resins, polyurethanes, unsaturated polyethers, polyglycol vinyl ethers, polyglycol divinyl ethers, copolymers thereof, and those described in U.S. Pat. No. 6,183,901 to Ying et al. of the common assignee for protective coating layers for separator layers. Those of ordinary skill in the art can choose appropriate polymers that can be crosslinked, as well as suitable methods of crosslinking, based upon general knowledge of the art in combination with the description herein.

Other classes of polymers that may be suitable for use in a release layer and/or an adhesion promoter (either crosslinked or non-crosslinked) include, but are not limited to, polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton)); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(2-vinyl pyridine), poly(isohexylcynaoacrylate), polyisobutylene, poly(methyl styrene), poly(methylmethacrylate) (PMMA), polyethylacrylate, polymethylmethacrylate, polyethylmethacrylate, UV curable acrylates or methacrylates); polyacetals; polyolefins (e.g., poly(butene-1), poly(n-pentene-2), polypropylene); polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO), heat curable divinyl ethers); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene, ethylene-propylene-diene (EPDM) rubbers); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). The mechanical and physical properties (e.g., conductivity, resistivity) of these polymers are known. Accordingly, those of ordinary skill in the art can choose suitable polymers for use as release layers and/or for use in an adhesion promoter based on factors such as their mechanical and/or electronic properties, adhesive affinity to carrier substrates and/or components of a cell, and solubility in a particular solvent or electrolyte, and other factors described herein, by, for example, tailoring the amounts of components of polymer blends, adjusting the degree of cross-linking (if any), etc. Simple screening tests such as those described herein can be used to select polymers that have the physical/mechanical properties.

The molecular weight of a polymer may also affect adhesive affinity and can vary in a release layer (e.g., a conductive release layer) and/or in an adhesion promoter. For example, the molecular weight of a polymer used in a release layer and/or an adhesion promoter may be between 1,000 g/mol and 5,000 g/mol, 5,000 g/mol and 10,000 g/mol, between 10,000 g/mol and 15,000 g/mol, between, 15,000 g/mol and 20,000 g/mol, between 20,000 g/mol and 30,000 g/mol, between 30,000 g/mol and 50,000 g/mol, between 50,000 g/mol and 100,000 g/mol, or between 100,000 g/mol and 200,000 g/mol. Other molecular weight ranges are also possible. In some embodiments, the molecular weight of a polymer used in a release layer and/or an adhesion promoter may be greater than about 1,000 g/mol, greater than about 5,000 g/mol, greater than about 10,000 g/mol, greater than about 15,000 g/mol, greater than about 20,000 g/mol, greater than about 25,000 g/mol, greater than about 30,000 g/mol, greater than about 50,000 g/mol, greater than about 100,000 g/mol or greater than about 150,000 g/mol. In other embodiments, the molecular weight of a polymer used in a release layer and/or an adhesion promoter may be less than about 150,000 g/mol, less than about 100,000 g/mol, less than about 50,000 g/mol, less than about 30,000 g/mol, less than about 25,000 g/mol, less than about 20,000 g/mol, less than less than about 10,000 g/mol, about 5,000 g/mol, or less than about 1,000 g/mol.

A release layer (e.g., a conductive release layer) and/or an adhesion promoter may include one or more crosslinking agents. A crosslinking agent is a molecule with a reactive portion(s) designed to interact with functional groups on the polymer chains in a manner that will form a crosslinking bond between one or more polymer chains. Examples of crosslinking agents that can crosslink polymeric materials used for release layers and/or adhesion promoters described herein include, but are not limited to: polyamide-epichlorohydrin (polycup 172); aldehydes (e.g., formaldehyde and urea-formaldehyde); dialdehydes (e.g., glyoxal glutaraldehyde, and hydroxyadipaldehyde); acrylates (e.g., ethylene glycol diacrylate, di(ethylene glycol) diacrylate, tetra(ethylene glycol) diacrylate, methacrylates, ethelyne glycol dimethacrylate, di(ethylene glycol) dimethacrylate, tri(ethylene glycol) dimethacrylate); amides (e.g., N,N′-methylenebisacrylamide, N,N′-methylenebisacrylamide, N,N′-(1,2-dihydroxyethylene)bisacrylamide, N-(1-hydroxy-2,2-dimethoxyethyl)acrylamide); silanes (e.g., methyltrimethoxysilane, methyltriethoxysilane, tetramethoxysilane (TMOS), tetraethoxysilane (TEOS), tetrapropoxysilane, methyltris(methylethyldetoxime)silane, methyltris(acetoxime)silane, methyltris(methylisobutylketoxime)silane, dimethyldi(methylethyldetoxime)silane, trimethyl(methylethylketoxime)silane, vinyltris(methylethylketoxime)silane, methylvinyldi(mtheylethylketoxime)silane, methylvinyldi(cyclohexaneoneoxxime)silane, vinyltris(mtehylisobutylketoxime)silane, methyltriacetoxysilane, tetraacetoxysilane, and phenyltris(methylethylketoxime)silane); divinylbenzene; melamine; zirconium ammonium carbonate; dicyclohexylcarbodiimide/dimethylaminopyridine (DCC/DMAP); 2-chloropyridinium ion; 1-hydroxycyclohexylphenyl ketone; acetophenon dimethylketal; benzoylmethyl ether; aryl trifluorovinyl ethers; benzocyclobutenes; phenolic resins (e.g., condensates of phenol with formaldehyde and lower alcohols, such as methanol, ethanol, butanol, and isobutanol), epoxides; melamine resins (e.g., condensates of melamine with formaldehyde and lower alcohols, such as methanol, ethanol, butanol, and isobutanol); polyisocyanates; dialdehydes; and other crosslinking agents known to those of ordinary skill in the art.

In embodiments including a crosslinked polymeric material and a crosslinking agent, the weight ratio of the polymeric material to the crosslinking agent may vary for a variety of reasons including, but not limited to, the functional-group content of the polymer, its molecular weight, the reactivity and functionality of the crosslinking agent, the desired rate of crosslinking, the degree of stiffness/hardness desired in the polymeric material, and the temperature at which the crosslinking reaction may occur. Non-limiting examples of ranges of weight ratios between the polymeric material and the crosslinking agent include from 100:1 to 50:1, from 20:1 to 1:1, from 10:1 to 2:1, and from 8:1 to 4:1.

A release layer (e.g., a conductive release layer) and/or an adhesion promoter may include one or more solvents, e.g., in its initial formulation when being applied to a component of an electrochemical cell. The particular solvent or solvent combination used may depend on, for example, the type and amounts of any other materials in the formulation, the method of applying the formulation to the cell component, the inertness of the solvent with respect to other components of the electrochemical cell (e.g., current collector, electroactive layer, electrolyte). For example, a particular solvent or solvent combination may be chosen based in part on its ability to solvate or dissolve any other materials (e.g., a polymer, filler, etc.) in the formulation. For adhesion promoter formulations, the particular solvent or solvent combination may be chosen based in part on its ability to solvate or dissolve portions of a release layer to which the adhesion promoter formulation comes in contact, and/or its ability to activate a surface of the release layer to promote adhesion. In some cases, one or more solvents used can wet (and activate) a surface of a release layer to promote adhesion but does not penetrate across the release layer. A combination of such and other factors may be taken into consideration when choosing appropriate solvents.

Non-limiting examples of suitable solvents may include aqueous liquids, non-aqueous liquids, and mixtures thereof. In some embodiments, solvents that may be used for a release layer and/or a adhesion promoter include, for example, water, methanol, ethanol, isopropanol, propanol, butanol, tetrahydrofuran, dimethoxyethane, acetone, toluene, xylene, acetonitrile, cyclohexane, and mixtures thereof can be used. Additional examples of non-aqueous liquid solvents include, but are not limited to, N-methyl acetamide, acetonitrile, acetals, ketals, esters, carbonates, sulfones, sulfites, sulfolanes, sulfoxides, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are may also be used. Of course, other suitable solvents can also be used as needed.

In one set of embodiments involving the use of a solvent combination for an adhesion promoter, a first solvent of the solvent combination may be used to solvate, dissolve, and/or activate portions of a release layer (e.g., a conductive release layer) to which the adhesion promoter formulation comes in contact, and a second solvent may be used to dilute or decrease the viscosity of the adhesion promoter formulation. For example, in one particular set of embodiments, an adhesion promoter, which may be used to facilitate adhesion between two release layers comprising a polymer including pendant hydroxyl functional groups (e.g., PVOH), may include a first solvent that solvates, dissolves, or activates the pendant hydroxyl functional groups to promote adhesion between the release layers. The first solvent may be, for example, a sulfoxide or any other suitable solvent that can dissolve, solvate, or activate a polymer including pendant hydroxyl functional groups (e.g., PVOH). The adhesion promoter may further include a second solvent that is miscible with the first solvent. The second solvent may, for example, be used to dilute or decrease the viscosity of the adhesion promoter formulation and/or increase the vapor pressure of the adhesion promoter formulation. Additional solvents (e.g., third, fourth solvents) may also be included in the solvent combination. As described herein, one or more of the solvents of the solvent combination may be inert with respect to other components of the cell (e.g., current collector, electroactive layer, electrolyte).

A solvent combination including a first solvent that may be used to solvate, dissolve, and/or activate portions of a release layer (e.g., a conductive release layer) to which the adhesion promoter formulation comes in contact, and at least a second solvent (such as one having the properties described above), may include an amount of the first solvent of greater than about 1 wt %, greater than about 5 wt %, greater than about 10 wt %, greater than about 20 wt %, greater than about 30 wt %, greater than about 40 wt %, greater than about 50 wt %, greater than about 60 wt %, greater than about 70 wt %, greater than about 80 wt %, or greater than about 90 wt % with respect to the total solvent combination. In other embodiments, the first solvent is present at an amount of less than about 90 wt %, less than about 80 wt %, less than about 70 wt %, less than about 60 wt %, less than about 50 wt %, less than about 40 wt %, less than about 30 wt %, less than about 20 wt %, less than about 10 wt %, less than about 5 wt %, less than about 3 wt %, or less than about 1 wt % with respect to the total solvent combination.

As described herein, an adhesion promoter may include in its formulation one or more solvents that can be used to facilitate adhesion between two components (e.g., release layers, conductive release layers) of an electrochemical cell. In some cases, the adhesion promoter includes in its formulation a solvent or solvent combination without any polymer. In other embodiments, the adhesion promoter includes in its formulation a solvent or solvent combination along with a polymer, such as those described herein, that may act as an adhesive. The amount of polymer in the adhesion promoter formulation that is applied to a component of an electrochemical cell may be, for example, less than or equal to about 20 wt %, less than or equal to about 15 wt %, less than or equal to about 10 wt %, less than or equal to about 7 wt %, less than or equal to about 5 wt %, less than or equal to about 4 wt %, less than or equal to about 3 wt %, less than or equal to about 2 wt %, less than or equal to about 1 wt %, less than or equal to about 0.5%, or less than or equal to about 0.1% with respect to the total weight of the adhesion promoter formulation.

The use of a polymer in an adhesion promoter formulation may, in some instances, decrease the time required to promote adhesion between components of the cell compared to using a similar adhesion promoter formulation but without the polymer, all other conditions being equal. For instance, adhesion using an adhesion promoter that includes a polymer may take place greater than or equal to 2 times, 3 times, 4 times, 5 times, or 10 times faster than adhesion using an adhesion promoter that does not includes the polymer. The use of an adhesion promoter formulation without a polymer, however, may simplify the adhesion process.

The thickness of a release layer (e.g., a conductive release layer) and/or a layer formed by an adhesion promoter (if a layer is formed at all) may vary over a range of thicknesses. Typically, the thickness of a release layer is greater than the thickness of a layer formed by an adhesion promoter. The thickness of a release layer may vary, for example, from about 0.1 microns to about 50 microns, and the thickness of a layer formed by an adhesion promoter may vary, for example, from about 0.001 microns to about 50 microns. In some cases, an adhesion promoter is applied but does not result in the formation of a layer having any appreciable thickness.

In some embodiments, the thickness of the release layer (e.g., the conductive release layer) and/or adhesion promoter layer may be between 0.001-1 microns thick, between 0.001-3 microns thick, between 0.01-3 microns thick, between 0.01-5 microns thick, between 0.1-1 microns thick, between 0.1 and 2 microns thick, between 0.1 and 3 microns thick, between 1-5 microns thick, between 5-10 microns thick, between 5-20 microns thick, or between 10-50 microns thick. In some embodiments, the thickness of a release layer and/or a layer formed by an adhesion promoter is, e.g., about 10 microns or less, about 7 microns or less, about 5 microns or less, about 3 microns or less, about 2.5 microns or less, about 2 microns or less, about 1.5 microns or less, about 1 micron or less, or about 0.5 microns or less. As noted above, a relatively thicker release layer may be suitable for applications where the release layer is not incorporated into an electrochemical cell (e.g., it is released along with a carrier substrate), and a relatively thinner release layer may be desirable where the release layer is incorporated into the electrochemical cell.

The Inventors have discovered within the context of this disclosure that certain conductive release layers can provide relatively good adhesion to a first surface (e.g., a carrier substrate) and relatively poor adhesion to a second surface (e.g., a current collector) by modifying the composition of one or more of the layers during processing. In one embodiment, this is achieved by including one or more components (e.g., a surfactant and/or a filler) in the release layer that interact favorably with the first surface to be adhered to promote adhesion and interacts poorly to the second surface to promote release.

In some cases, conductive fillers may be added to the material used to form a release layer (and/or an adhesion promoter), in addition to the conductive carbon species described above. Conductive fillers can increase the electrically conductive properties of the material of the release layer and may include, for example, conductive carbons such as carbon black (e.g., Vulcan XC72R carbon black, Printex Xe-2, or Akzo Nobel Ketjen EC-600 JD), graphite fibers, graphite fibrils, graphite powder (e.g., Fluka #50870), activated carbon fibers, carbon fabrics, non-activated carbon nanofibers. Other non-limiting examples of conductive fillers include metal coated glass particles, metal particles, metal fibers, nanoparticles, nanotubes, nanowires, metal flakes, metal powders, metal fibers, metal mesh.

A non-conductive or a semi-conductive filler (e.g., silica particles) can also be included in a release layer.

The amount of filler in a release layer, if present, may be present in the range of, for example, 5-10%, 10-90% or 20-80% by weight of the release layer (e.g., as measured after an appropriate amount of solvent has been removed from the release layer and/or after the layer has been appropriately cured). For instance, the release layer may include a conductive filler in the range of 20-40% by weight, 20-60% by weight, 40-80% by weight, 60-80% by weight of the release layer.

Additionally, where the conductive release layer is in contact with an electroactive layer, the electroactive layer may include certain chemical compositions that interact favorably with the conductive release layer and which remain in the electroactive layer even after drying. For example, the electroactive layer may include a polymeric material (e.g., a binder) or other material containing certain functional groups (e.g., hydroxyl or ether groups) that can interact with those of the release layer. In one particular embodiment, both the electroactive layer and the release layer include one or more polymers that can crosslink with each other. The release layer may be prepared such that it has a relatively high amount (e.g., an excess) of crosslinking agent. Upon positioning of the slurry containing the electroactive layer adjacent the release layer, crosslinking agent at the interface of the two layers can cause crosslinking between a polymer in the electroactive layer and a polymer in the release layer.

In other embodiments, a release layer (e.g., a conductive release layer) may be prepared such that it has a relatively high amount (e.g., an excess) of crosslinking agent, and upon positioning of an adhesion promoter adjacent the release layer, crosslinking agent at the interface of the two layers can cause crosslinking between a polymer in the adhesion promoter and a polymer in the release layer.

Determining suitable compositions, configurations (e.g., crosslinked or substantially uncrosslinked, degree of hydrolyzation) and dimensions of release layers (e.g., conductive release layers) and/or adhesion promoters can be carried out by those of ordinary skill in the art, without undue experimentation. As described herein, a release layer may be chosen based on, for example, its inertness in the electrolyte and whether the release layer is to be incorporated into the electrochemical cell. The particular materials used to form the release layer may depend on, for example, the material compositions of the layers to be positioned adjacent the release layer and its adhesive affinity to those layers, as well as the thicknesses and method(s) used to deposit each of the layers. The dimensions of the release layer may be chosen such that the electrochemical cell has a low overall weight, while providing suitable release properties during fabrication.

One simple screening test for choosing appropriate materials for a release layer may include forming the release layer and immersing the layer in an electrolyte and observing whether inhibitory or other destructive behavior (e.g., disintegration) occurs compared to that in a control system. The same can be done with other layers (e.g., one or more of the conductive release layers, electroactive layer, an adhesion promoter, and/or another release layer) attached to the release layer. Another simple screening test may include forming an electrode including the one or more release layers and immersing the electrode in the electrolyte of the battery in the presence of the other battery components, discharging/charging the battery, and observing whether specific discharge capacity is higher or lower compared to a control system. A high discharge capacity may indicate no or minimal adverse reactions between the release layer and other components of the battery.

To test whether a release layer (e.g., a conductive release layer) has adequate adhesion to one surface but relatively low adhesion to another surface to allow the release layer to be released, the adhesiveness or force required to remove a release layer from a unit area of a surface can be measured (e.g., in units of N/m²). Adhesiveness can be measured using a tensile testing apparatus or another suitable apparatus. Such experiments can optionally be performed in the presence of a solvent (e.g., an electrolyte) or other components (e.g., fillers) to determine the influence of the solvent and/or components on adhesion. In some embodiments, mechanical testing of tensile strength or shear strength can be performed. For example, a release layer may be positioned on a first surface and opposite forces can be applied until the surfaces are no longer joined. The (absolute) tensile strength or shear strength is determined by measuring the maximum load under tensile or shear, respectively, divided by the interfacial area between the articles (e.g., the surface area of overlap between the articles). The normalized tensile strength or shear strength can be determined by dividing the tensile strength or shear strength, respectively, by the mass of the release layer applied to the articles. In one set of embodiments, a “T-peel test” is used. For example, a flexible article such as a piece of tape can be positioned on a surface of the release layer, and the tape can be pulled away from the surface of the other layer by lifting one edge and pulling that edge in a direction approximately perpendicular to the layer so that as the tape is being removed, it continually defines a strip bent at approximately 90 degrees to the point at which it diverges from the other layer. In other embodiments, relative adhesion between layers can be determined by positioning a release layer between two layers (e.g., between a carrier substrate and a current collector), and a force applied until the surfaces are no longer joined. In some such embodiments, a release layer that adheres to a first surface but releases from a second surface, without mechanical disintegration of the release layer, may be useful as a release layer for fabricating components of an electrochemical cell. The effectiveness of an adhesion promoter to facilitate adhesion between two surfaces can be tested using similar methods. Other simple tests are known and can be conducted by those of ordinary skill in the art.

The percent difference in adhesive strength between the release layer and the two surfaces in which the release layer is in contact may be calculated by taking the difference between the adhesive strengths at these two interfaces. For instance, for a release layer positioned between two layers (e.g., between a carrier substrate and a current collector), the adhesive strength of the release layer on the first layer (e.g., a carrier substrate) can be calculated, and the adhesive strength of the release layer on the second layer (e.g., a current collector) can be calculated. The smaller value can then be subtracted from the larger value, and this difference divided by the larger value to determine the percentage difference in adhesive strength between each of the two layers and the release layer. In some embodiments, this percent difference in adhesive strength is greater than about 20%, greater than about 30%, greater than about 40%, greater than about 50%, greater than about 60%, greater than about 70%, or greater than about 80%. The percentage difference in adhesive strength may be tailored by methods described herein, such as by choosing appropriate materials for each of the layers.

A peel test may include measuring the adhesiveness or force required to remove a layer (e.g., a conductive release layer) from a unit area of a surface of a second layer (e.g., an electroactive layer), which can be measured in N/m, using a tensile testing apparatus or another suitable apparatus. One example of a peel test that can be used is the MARK-10 BG5 gauge with ESM301 motorized test stand.

In some embodiments, the strength of adhesion between two layers (e.g., a conductive release layer and an electroactive layer, a conductive release layer and a carrier substrate) may range, for example, between 0.01 N/m to 2000 N/m. In some embodiments, the strength of adhesion may be greater than or equal to 0.01 N/m, greater than or equal to 0.02 N/m, greater than or equal to 0.04 N/m, greater than or equal to 0.06 N/m, greater than or equal to 0.08 N/m, greater than or equal to 0.1 N/m, greater than or equal to 0.5 N/m, greater than or equal to 1 N/m, greater than or equal to 10 N/m, greater than or equal to 25 N/m, greater than or equal to 50 N/m, greater than or equal to 100 N/m, greater than or equal to 200 N/m, greater than or equal to 350 N/m, greater than or equal to 500 N/m, greater than or equal to 700 N/m, greater than or equal to 900 N/m, greater than or equal to 1000 N/m, greater than or equal to 1200 N/m, greater than or equal to 1400 N/m, greater than or equal to 1600 N/m, or greater than or equal to 1800 N/m. In certain embodiments, the strength of adhesion may be less than or equal to 2000 N/m, less than or equal to 1500 N/m, less than or equal to 1000 N/m, less than or equal to 900 N/m, less than or equal to 700 N/m, less than or equal to 500 N/m, less than or equal to 350 N/m, less than or equal to 200 N/m, less than or equal to 100 N/m, less than or equal to 50 N/m, less than or equal to 25 N/m, less than or equal to 10 N/m, less than or equal to 1 N/m, less than or equal to 0.5 N/m, less than or equal to 0.1 N/m, less than or equal to 0.08 N/m, less than or equal to 0.06 N/m, less than or equal to 0.04 N/m, less than or equal to 0.02 N/m, or less than or equal to 0.01 N/m. Combinations of the above-referenced ranges are also possible (e.g., greater than or equal to 0.1 N/m and less than or equal to 50 N/m). Other strengths of adhesion are possible.

Adhesion and/or release between a release layer and components of an electrochemical cell (including a second release layer) may involve associations such as adsorption, absorption, Van der Waals interactions, hydrogen bonding, covalent bonding, ionic bonding, cross linking, electrostatic interactions, and combinations thereof. The type and degree of such interactions can also be tailored by methods described herein.

A release layer (e.g., a conductive release layer) can be fabricated by any suitable method. In some embodiments, thermal evaporation, vacuum deposition, sputtering, jet vapor deposition, or laser ablation can be used to deposit a release layer on a surface.

In some embodiments, a release layer is fabricated by first forming a release layer formulation, and then positioning the release layer formulation on a surface by a suitable method. In some cases, the release layer formulation is in the form of a slurry. The slurry may include any suitable solvent that can at least partially dissolve or disperse the conductive release layer material (e.g., a polymer). For example, a conductive release layer predominately formed of a hydrophobic material may include an organic solvent in the slurry, whereas a conductive release layer predominately formed of a hydrophilic material may include water in the slurry. In some embodiments, the slurry can include other solvents in addition to, or in place of, water (e.g., other solvents that can form a hydrogen bond), which can result in favorable interactions with components of the release layer. For example, alcohols such as methanol, ethanol, butanol, or isopropanol can be used. In some cases, a release layer slurry includes greater than or equal to 10 wt %, greater than or equal to 15 wt %, greater than or equal to 20 wt %, greater than or equal to 20 wt %, greater than or equal to 30 wt %, greater than or equal to 40 wt %, or greater than or equal to wt % of an alcohol. Other solvents such as esters, glymes, and ethers can also be used alone or in combination with other solvents, in some embodiments.

Mixing or dispersing of the various components can be accomplished using any of a variety of methods known in the art so long as the desired dissolution, dispersion, or suspension of the components is obtained. For example, some embodiments comprise stirring the slurry. Suitable methods of mixing or dispersing include, but are not limited to, mechanical agitation, grinding, ultrasonication, ball milling, sand milling, and impingement milling.

In some embodiments, dispersing comprises milling the slurry containing the plurality of conductive carbon species. In some such embodiments, milling comprises ball milling the slurry, and, in some embodiments, ball milling comprises ball milling with a plurality of metal balls. Ball mailing (e.g., balling with metal balls) can break up agglomerates of conductive carbon species (e.g., agglomerates of carbon black) and facilitate adequate mixing of the conductive carbon species with other components of the slurry (e.g., polymeric binder).

Mixing of the various components can occur at various temperatures. For instance, the various components may be mixed at a temperature of greater than or equal to 25° C., greater than or equal to 50° C., greater than or equal to 70° C., or greater than or equal to 90° C. for a suitable amount of time to obtain a desired dissolution or dispersion of components. For example, in some instances, a polymer used for a release layer (e.g., polyvinyl alcohol) is mixed at a temperature of greater than or equal 70° C. or greater than or equal to 90° C. In other embodiments, various components such as a polymeric material and a solvent may be mixed at a temperature of less than or equal to 50° C., less than or equal to 70° C., or less than or equal to 90° C. for a suitable amount of time to obtain a desired dissolution or dispersion of components. Mixing at such and other temperatures may be performed until the polymer is dissolved and/or dispersed as desired. This solution/dispersion can optionally be mixed with other components of the release layer (e.g., a conductive filler, solvent, crosslinker, etc.), e.g., at a suitable temperature, to form a release layer slurry.

A release layer (e.g., a conductive release layer) and/or an adhesion promoter may be positioned on a surface by any suitable method. In some embodiments, a release layer and/or an adhesion promoter is positioned on a surface by slot die coating or reverse roll coating. In each of these methods, the release layer formulation can be delivered as a slurry to a surface such as a carrier substrate, which may then optionally undergo any number of curing, drying, and/or treatment steps, prior to lamination of the carrier/release/electrode into a single stack. Similarly, an adhesion promoter may be applied to a surface of a release layer which may then optionally undergo any number of curing, drying, and/or treatment steps, prior to lamination of the carrier/release/electrode into a single stack. In some embodiments, the thickness of the coating, mechanical integrity, and/or coating uniformity may be tailored by varying the parameters of the coating method used.

Several aspects of the coating method can be controlled to produce a suitable release layer (e.g., a conductive release layer). When coating a very thin release layer, the mechanical integrity is dependent on coating uniformity. Both particulate contamination and undesired precipitation from solution can lead to poor mechanical properties in the final release layer. To prevent these defects, several steps can be taken. For example, a method may involve keeping the surface to be coated with the release layer substantially free of static charging, which can affect the adhesion of the release layer to that surface and can additionally attract unwanted particulate contaminants on the surface. Static charging can be reduced or eliminating by applying static strings to the substrate unwind or controlling the electronic state of the coat rolls (e.g., attached to ground, floating, biased). A method can also be employed to prevent unwanted precipitation out of the coating solution, e.g., by employing continuous mixing to prevent coagulation. Other techniques are also known to those by ordinary skill in the art.

In one set of embodiments, slot die coating is used to form a release layer coating (e.g., a conductive release layer) and/or an adhesion promoter coating on a surface. In slot die coating, a fluid is delivered by a pump to a die which in turn delivers the coating fluid to the desired substrate. The die will usually include three pieces: a top, a bottom, and an internal shim. Either the top or bottom may include a well or reservoir to hold fluid and spread it across the width of the die. The shim determines both the size of the gap between the top and bottom plates as well as defining the coating width.

Thickness of the coating in this case may depend mainly on three factors: the rate at which fluid is delivered to the die (pump speed), the speed at which the substrate is moving past the die lips (line speed), and the size of the gap in the die lips (slot height). Thickness will additionally depend on the inherent properties of the solution to be coated such as viscosity and percent solids.

The uniformity of the coating will be directly related to how well the internal manifold in the die distributes the fluid across the substrate. To control coating uniformity, several steps can be taken. For example, the shape of the reservoir can be adjusted to equalize pressure across the width of the die. The shape of internal shim can be adjusted to account for pressure variations due to the position of the fluid inlet. The internal shim thickness can also be adjusted to produce higher or lower pressure drops between the fluid inlet and the die lips. The pressure drop will determine the residence time of the fluid in the die and can be used to influence coating thickness and prevent problems such as dry out in the die.

In another set of embodiments, reverse roll coating is used to form a release layer coating (e.g., a conductive release layer coating) and/or an adhesion promoter coating on a surface. In one embodiment, a three-roll reverse roll coater fluid is picked up by a first roller (metering roller), transferred in a controlled fashion to a second roller (application roller), and then wiped off of the second roller by the substrate as it travels by. More rollers can be used employing a similar technique. The coating fluid is delivered to a reservoir by a pump; the metering roller is positioned so that it is partially submerged in the coating fluid when the pan is filled. As the metering roller spins the application roller is moved (or vice versa) so that fluid is transferred between the two.

The amount of fluid, and in turn the final coat thickness of the release layer (e.g., the conductive release layer) and/or an adhesion promoter, is partially determined by the amount of fluid transferred to the application roller. The amount of fluid transfer can be affected by changing the gaps between the rollers or by applying a doctor blade at any point in the process. Coating thickness is also affected by line speed in a way similar to slot die coating. Coating uniformity in the case of reverse roll coating may depend mainly on the uniformity of the coat rolls and the doctor blade(s) if any are used.

It should be understood that the compositions and methods described herein may be used to form release layers (e.g., conductive release layers) and/or adhesion promoter layers for fabricating electrodes (e.g., anodes and cathodes), as well as other applications that would benefit from the use of a release layer.

As described herein, a release layer (e.g., a conductive release layer) may be positioned on a carrier substrate to facilitate fabrication of component of an electrochemical cell. Any suitable material can be used as a carrier substrate. As described above, the material (and thickness) of a carrier substrate may be chosen at least in part due to its ability to withstand certain processing conditions such as high temperature. The substrate material may also be chosen at least in part based on its adhesive affinity to a release layer. In some cases, a carrier substrate is a polymeric material. Examples of suitable materials that can be used to form all or portions of a carrier substrate include certain of those described herein suitable as release layers, optionally with modified molecular weight, cross-linking density, and/or addition of additives or other components. In some embodiments, a carrier substrate comprises polyethylene terephthalate (PET) or a polyester. In other cases, a carrier substrate comprises a metal, a metal foil (e.g., aluminum, nickel, copper and/or iron), or a ceramic material. A carrier substrate may also include additional components such as fillers, binders, and/or surfactants.

Additionally, a carrier substrate may have any suitable thickness. For instance, the thickness of a carrier substrate may about 5 microns or greater, about 15 microns or greater, about 25 microns or greater, about 50 microns or greater, about 75 microns or greater, about 100 microns or greater, about 200 microns or greater, about 500 microns or greater, or about 1 mm or greater. In some cases, the carrier substrate has a thickness that is equal to or greater than the thickness of the release layer. As described herein, a relatively thicker carrier substrate may be suitable for applications where the carrier substrate is not incorporated into an electrochemical cell (e.g., it is released through the use of a release layer during fabrication of the cell). In some embodiments, the carrier substrate is incorporated into the electrochemical cell, and in some such instances it may be desirable to use a relatively thinner carrier substrate.

An electrochemical cell may include any suitable current collector. In some instances, the current collector is positioned immediately adjacent a conductive release layer (e.g., on top of a conductive release layer that has been positioned on a carrier substrate). The current collector may have good adhesion to the conductive release layer release layer where the release layer is designed to be a part of the final electrochemical cell, or the current collector may have poor adhesion to the conductive release layer where the conductive release layer is designed to be released along with a carrier substrate.

A current collector is useful in efficiently collecting the electrical current generated throughout an electrode and in providing an efficient surface for attachment of the electrical contacts leading to the external circuit. A wide range of current collectors are known in the art. Suitable current collectors may include, for example, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein.

In some embodiments, the current collector includes one or more conductive metals such as aluminum, copper, chromium, stainless steel and nickel. For example, a current collector may include a copper metal layer. Optionally, another conductive metal layer, such as titanium may be positioned on the copper layer. The titanium may promote adhesion of the copper layer to another material, such as an electroactive layer. Other current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In other embodiments, however, a current collector may comprise an electroactive layer. For example, a current collector may include a material which is used as an electroactive layer (e.g., as an anode or a cathode such as those described herein).

A current collector may be positioned on a surface (e.g., a surface of a conductive release layer) by any suitable method such as lamination, sputtering, and vapor deposition. In some cases, a current collector is provided as a commercially available sheet that is laminated with an electrochemical cell component. In other cases, a current collector is formed during fabrication of the electrode by depositing a conductive material on a suitable surface.

A current collector may have any suitable thickness. For instance, the thickness of a current collector may be, for example, between 0.1 and 0.5 microns thick, between 0.1 and 0.3 microns thick, between 0.1 and 2 microns thick, between 1-5 microns thick, between 5-10 microns thick, between 5-20 microns thick, or between 10-50 microns thick. In some embodiments, the thickness of a current collector is, e.g., about 20 microns or less, about 12 microns or less, about 10 microns or less, about 7 microns or less, about 5 microns or less, about 3 microns or less, about 1 micron or less, about 0.5 micron or less, or about 0.3 micron or less. In some embodiments, the use of a release layer during fabrication of an electrode can allow the formation or use of a very thin current collector, which can reduce the overall weight of the cell, thereby increasing the cell's energy density.

In some embodiments, release layers described herein can be used to form a cathode. The release layer may adhere to one or more components of a cathode in the final electrochemical cell, or the release layer may be released along with a carrier substrate in some embodiments. Suitable electroactive layers for use as cathode active materials in the cathode of the electrochemical cells described herein include, but are not limited to, electroactive transition metal chalcogenides, electroactive conductive polymers, electroactive sulfur-containing materials, and combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, carbon, iodine, silver chromate, silver oxide and vanadium pentoxide, vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Preferred conductive polymers include polypyrroles, polyanilines, and polyacetylenes.

Any negative electrode material suitable as an electroactive layer (e.g., an anode) may benefit from some embodiments. Examples of suitable negative electrode materials for anode active layers include, but are not limited to, alkali-based materials such as lithium metal and lithium ion. Lithium metal anodes may be formed from lithium sources such as lithium foil, lithium deposited onto a conductive substrate, and lithium alloys (e.g., lithium-aluminum alloys and lithium-tin alloys). An anode active layer may consist essentially of lithium in some embodiments. In some embodiments, lithium metal or a lithium metal alloy may be present during only a portion of the charge/discharge cycle. In such embodiments, the cell could be assembled without any lithium metal or lithium metal alloy on an anode current collector, and the lithium metal or lithium metal alloy may subsequently be deposited at the anode during a charging step. In some cases, the anodes described in U.S. patent application Ser. No. 11/821,576, filed Jun. 22, 2007, entitled “Lithium Alloy/Sulfur Batteries”, which is incorporated herein by reference in its entirety, are combined with embodiments within the present disclosure. It should be understood that other cell chemistries may also be used, such as zinc and copper anodes, and that other types of batteries can benefit from the methods and articles described herein.

Methods for depositing a negative electrode material (e.g., an alkali metal anode such as lithium) onto a surface (e.g., a surface of a current collector or a release layer) may include methods such as thermal evaporation (e.g., vacuum deposition), sputtering, jet vapor deposition, and laser ablation. Alternatively, where the anode comprises a lithium foil, or a lithium foil and a surface, these can be laminated together by a lamination process as known in the art to form an anode.

In some embodiments, the negative electrode material layer(s) has a low surface roughness, e.g., a root mean square (RMS) surface roughness of less than about 1 micron, less than about 500 nm, less than about 100 nm, less than about 50 nm, less than about 25 nm, less than about 10 nm, less than about 5 nm, less than about 1 nm, or less than about 0.5 nm. Smooth negative electrode material layers can be achieved, in some embodiments, by controlling vacuum deposition of the negative electrode material. The negative electrode material may be deposited onto a smooth surface (e.g., a smooth current collector layer) having the same or a similar RMS surface roughness as the desired negative electrode material layer. Such and other methods can produce negative electrode material layer(s) that are greater than or equal to 1.5×, 2×, 3×, 4×, 5×, or even 10× smoother than certain commercially available foils, resulting in substantially uniformly smooth surfaces.

Positive and/or negative electrodes may optionally include one or more layers that interact favorably with a suitable electrolyte, such as those described in International Patent Apl. Serial No. PCT/US2007/024805, filed Dec. 4, 2007 and entitled “Separation of Electrolytes”, by Mikhaylik et al., which is incorporated herein by reference in its entirety for all purposes.

Furthermore, an electrochemical cell may have more than one electroactive layer in some embodiments. For example, a first electroactive layer material may be separated from a second electroactive layer by a stabilization layer, as described in more detail in U.S. patent application Ser. No. 11/400,781, filed Apr. 6, 2006, published as U.S. Patent Publication No. 2007/0221265, entitled, “Rechargeable Lithium/Water, Lithium/Air Batteries” to Affinito et al., which is incorporated herein by reference in its entirety.

An electroactive layer (e.g., used as an anode or cathode) may have any suitable thickness. For instance, the thickness of the electroactive layer may vary from, e.g., about 2 to 200 microns. For instance, the electroactive layer may have a thickness of about 200 microns or less, about 100 microns or less, about 50 microns or less, about 35 microns or less, about 25 microns or less, about 15 microns or less, about 10 microns or less, or about 5 microns or less. In other instances, the electroactive layer has a thickness of about 5 microns or greater, about 15 microns or greater, about 25 microns or greater, about 50 microns or greater, or about 100 microns or greater. The choice of thickness may depend on cell design parameters such as the cycle life of the cell desired. In some embodiments, the thickness of the electroactive layer is in the range of about 2 to 100 microns (e.g., in the range of about 5 to 50 microns, in the range of about 2-10 microns, in the range of about 5 to 25 microns, or in the range of about 10 to 25 microns).

In some embodiments where the anode includes more than one anode active layer (e.g., multiple vapor-deposited lithium metal layers interspersed between one or more anode stabilization layers), each of such anode active layers may be relatively thin, e.g., between 2-5 microns thick and/or between 8-15 microns thick. In one set of embodiments, an anode includes at least first and second anode active layers, the first anode active layer being adjacent a current collector, and the second anode active layer being closer in distance to an electrolyte than the first layer, and being separated from the first layer by one or more intervening layers (e.g., a polymer layer, a single-ion conductive layer, a ceramic layer). In some instances, the first anode active layer is thicker than the second anode active layer. In other instances, the second anode active layer is thicker than the first anode active layer. The thicknesses of such layers may vary in thickness and may have, for example, a range of thickness as described above.

Advantageously, certain electrochemical cells formed at least in part by one or more methods described herein may have a relatively thin or light anode active layer with respect to the thickness and/or weight of the cell. Even though a relatively thinner or lighter anode active layer is used, an electrochemical cell incorporating such a component may achieve a similar or even higher energy density compared to cells having similar components but having a thicker anode active layer. Prior to the this disclosure, one of ordinary skill in the art may have used a relatively thicker anode active layer to compensate for factors that reduce the capacity of the cell during cycling such as decomposition of the anode active material, the formation of through-holes in the anode active layer(s) which propagate defects in the layer, the consumption of the anode active material and/or the solvent, and/or the formation of dendrites. That is, one may have included a thicker anode active layer knowing that not all of the anode active material would be consumed during the life of the cell due to one or more of the issues described above. The methods described herein, however, can allow one to incorporate a targeted amount of anode active material in an electrochemical cell to better match the requirements or capacity of the cathode, and/or to achieve a specific energy density target, while reducing excessive waste of anode active material.

For instance, in some embodiments, depositing a relatively thin and smooth current collector (e.g., via use of a release layer) can allow the deposition of a thin and smooth anode active layer. The smooth current collector can provide a conductive surface to re-plate lithium and promote smooth lithium morphology at high lithium depth of discharge (DoD). This can reduce or eliminate the formation of through-holes and/or other defects in the layer during charge or discharge, e.g., by reducing random current variations which may increase roughness with each cycle. As a result, a higher proportion of the anode active layer can be used in generating energy during cycling of the cell compared to a cell made without such and other processes.

In some embodiments, an electrochemical cell described herein includes a relatively thin anode active material (e.g., in the form of one or more layers having a combined thickness of about 50 microns or less, about 40 microns or less, about 30 microns or less, about 20 microns or less, or about 15 microns or less, about 10 microns or less, or about 5 microns or less) and a relatively thick battery (e.g., a thickness of about 10 microns or greater, about 50 microns or greater, about 100 microns or greater, about 200 microns or greater, about 500 microns or greater, about 1 mm or greater, or about 2 mm or greater). In some embodiments, the thickness of an electrochemical cell is between about 25 microns and about 75 microns thick, between about 50 to about 100 microns thick, or between about 75 microns to about 150 microns thick. The thickness of the cell can be measured from the outer surface of the anode, i.e., the surface of the anode most distant from the cathode (including any layer(s) supporting and/or adjacent the anode active material, such as a current collector or release layer) to the outer surface of the cathode i.e., the surface of the cathode most distant from the anode (including any layer(s) supporting and/or adjacent the cathode active material, such as a current collector or release layer), or in the case of stacked cells or cells in a rolled configuration, thickness can be determined by measuring the distance between repeat units of the cell (e.g., the shortest distance between a first cathode and a second cathode). In some cases, the thickness of the one or more anode active layers is less than 50%, 40%, 30%, 25%, 20%, 15%, 10%, or 5% the thickness of the cell. Optionally, such and other electrochemical cells described herein may include an anode active material adjacent a relatively thin current collector having a thickness provided above. The electrochemical cell may optionally include a thin release layer, and in some cases does not include a substrate (e.g., the electrochemical cell may be self-supporting).

Such and other electrochemical cells described herein may have an energy density (which can be expressed as Watt hours per kilogram (Wh/kg) or energy per size, as expressed as Watt hours per liter (Wh/l)) of, for example, greater than or equal to 200 Wh/kg (or Wh/l), greater than or equal to 250 Wh/kg (or Wh/l), greater than or equal to 300 Wh/kg (or Wh/l), greater than or equal to 350 Wh/kg (or Wh/l), greater than or equal to 400 Wh/kg (or Wh/l), greater than or equal to 450 Wh/kg (or Wh/l), or greater than or equal to 500 Wh/kg (or Wh/l). In some cases, such and other energy densities are achieved at or after the cell's 15th, 25th, 30th, 40th, 45th, 50th, or 60th discharge. It is to be understood that “at or after X^{th} discharge” means a time or times at or after a point where a rechargeable electrochemical device has been charged and discharged greater than or equal to X times, where charge means essentially full charge, and discharge means, on average of all discharges, greater than or equal to 75% discharge. In some cases, such and other electrochemical cells described herein have a discharge capacity of greater than or equal to 1000, 1200, 1600, or 1800 mAh at the end of the battery's 15^{th}, 25^{th}, 30^{th}, 40^{th}, 45^{th}, 50^{th}, or 60^{th} cycle. Furthermore, the electrochemical cell may be designed to cycle greater than or equal to 25, greater than or equal to 50, greater than or equal to 100, greater than or equal to 200, or greater than or equal to 500 times while maintaining, by the end of this cycling, greater than or equal to half of the maximum achievable discharge capacity of the cell. In one particular embodiment, an electrochemical cell made by processes described herein including a 10-micron-thick lithium active layer has a dense/smooth lithium surface from cycle 100 through cycle 350 at 100% Li depth of discharge.

An electrochemical cell described herein may include any suitable electrolyte. The electrolytes used in electrochemical cells described herein can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material is electrochemically and chemically unreactive with respect to the anode and the cathode, and the material facilitates the transport of ions (e.g., lithium ions) between the anode and the cathode. The electrolyte may be electronically non-conductive to prevent short circuiting between the anode and the cathode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in International Patent Apl. Serial No. PCT/US2007/024805, filed Dec. 4, 2007, published as International Publication No. WO2008/070059, and entitled “Separation of Electrolytes”, by Mikhaylik et al.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes for lithium cells. Aqueous solvents can include water, which can contain other components such as ionic salts. In some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

Examples of ionic electrolyte salts for use in the electrolytes of the present disclosure include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al.

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode.

A separator or a solid or gel electrolyte may have any suitable thickness. For instance, a separator or an electrolyte may have a thickness in the range of about 2 to about 100 microns (e.g., in the range of about 5 to about 50 microns, in the range of about 2 to about 10 microns, in the range of about 5 to about 25 microns, or in the range of about 10 to about 25 microns). In some cases, the distance between the outermost surface of the anode facing the electrolyte and the outermost surface of the cathode facing the electrolyte has such a thickness.

The pores of the separator may be partially or substantially filled with electrolyte. Separators may be supplied as porous free-standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al. In some embodiments, a separator is formed by using a release layer described herein.

A variety of separator materials are known in the art. Examples of suitable solid porous separator materials include, but are not limited to, polyolefins, such as, for example, polyethylenes and polypropylenes, glass fiber filter papers, and ceramic materials. Further examples of separators and separator materials suitable for use within this disclosure are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

The figures that accompany this disclosure are schematic only and illustrate a substantially flat battery arrangement. It should be understood that any electrochemical cell arrangement can be constructed, employing the principles of the present disclosure, in any configuration. For example, with reference to FIGS. 3A and 4B, electrode 12 may be covered on the side opposite the side at which components 26 and 28 are illustrated with a similar or identical set of components 26 and/or 28. In this arrangement, a substantially mirror-image structure is created with a mirror plane passing through electrode 12. This would be the case, for example, in a “rolled” battery configuration in which a layer of electrode 12 is surrounded on each side by structures 26 and/or 28 (or, in alternative arrangements layered structures illustrated in other figures herein). On the outside of each protective structure of the anode an electrolyte is provided and, opposite the electrolyte, an opposite electrode (e.g., an anode in the case of electrode 12 being a cathode). In a rolled arrangement, or other arrangement including multiple layers of alternating anode and cathode functionality, the structure involves anode, electrolyte, cathode, electrolyte, anode, etc., where each anode can include anode stabilization structures as described in any part of this disclosure, or in more detail in U.S. patent application Ser. No. 11/400,025, filed Apr. 6, 2006, published as U.S. Publication No. 2007/0224502, and entitled, “Electrode Protection in both Aqueous and Non-Aqueous Electrochemical Cells, including Rechargeable Lithium Batteries,” to Affinito et al., which is incorporated herein by reference in its entirety. Of course, at the outer boundaries of such an assembly, a “terminal” anode or cathode will be present. Circuitry to interconnect such a layered or rolled structure is well-known in the art.

The following applications are incorporated herein by reference, in their entirety, for all purposes: U.S. Patent Publication No. US 2007/0221265, published on Sep. 27, 2007, filed as application Ser. No. 11/400,781 on Apr. 6, 2006, and entitled “Rechargeable Lithium/Water, Lithium/Air Batteries”; U.S. Patent Publication No. US 2009/0035646, published on Feb. 5, 2009, filed as application Ser. No. 11/888,339 on Jul. 31, 2007, and entitled “Swelling Inhibition in Batteries”; U.S. Patent Publication No. US 2010/0129699, published on May 17, 2010, filed as application Ser. No. 12/312,674 on Feb. 2, 2010, patented as U.S. Pat. No. 8,617,748 on Dec. 31, 2013, and entitled “Separation of Electrolytes”; U.S. Patent Publication No. US 2010/0291442, published on Nov. 18, 2010, filed as application Ser. No. 12/682,011 on Jul. 30, 2010, patented as U.S. Pat. No. 8,871,387 on Oct. 28, 2014, and entitled “Primer for Battery Electrode”; U.S. Patent Publication No. US 2009/0200986, published on Aug. 31, 2009, filed as application Ser. No. 12/069,335 on Feb. 8, 2008, patented as U.S. Pat. No. 8,264,205 on Sep. 11, 2012, and entitled “Circuit for Charge and/or Discharge Protection in an Energy-Storage Device”; U.S. Patent Publication No. US 2007/0224502, published on Sep. 27, 2007, filed as application Ser. No. 11/400,025 on Apr. 6, 2006, patented as U.S. Pat. No. 7,771,870 on Aug. 10, 2010, and entitled “Electrode Protection in Both Aqueous and Non-Aqueous Electrochemical cells, Including Rechargeable Lithium Batteries”; U.S. Patent Publication No. US 2008/0318128, published on Dec. 25, 2008, filed as application Ser. No. 11/821,576 on Jun. 22, 2007, and entitled “Lithium Alloy/Sulfur Batteries”; U.S. Patent Publication No. US 2002/0055040, published on May 9, 2002, filed as application Ser. No. 09/795,915 on Feb. 27, 2001, patented as U.S. Pat. No. 7,939,198 on May 10, 2011, and entitled “Novel Composite Cathodes, Electrochemical Cells Comprising Novel Composite Cathodes, and Processes for Fabricating Same”; U.S. Patent Publication No. US 2006/0238203, published on Oct. 26, 2006, filed as application Ser. No. 11/111,262 on Apr. 20, 2005, patented as U.S. Pat. No. 7,688,075 on Mar. 30, 2010, and entitled “Lithium Sulfur Rechargeable Battery Fuel Gauge Systems and Methods”; U.S. Patent Publication No. US 2008/0187663, published on Aug. 7, 2008, filed as application Ser. No. 11/728,197 on Mar. 23, 2007, patented as U.S. Pat. No. 8,084,102 on Dec. 27, 2011, and entitled “Methods for Co-Flash Evaporation of Polymerizable Monomers and Non-Polymerizable Carrier Solvent/Salt Mixtures/Solutions”; U.S. Patent Publication No. US 2011/0006738, published on Jan. 13, 2011, filed as application Ser. No. 12/679,371 on Sep. 23, 2010, and entitled “Electrolyte Additives for Lithium Batteries and Related Methods”; U.S. Patent Publication No. US 2011/0008531, published on Jan. 13, 2011, filed as application Ser. No. 12/811,576 on Sep. 23, 2010, patented as U.S. Pat. No. 9,034,421 on May 19, 2015, and entitled “Methods of Forming Electrodes Comprising Sulfur and Porous Material Comprising Carbon”; U.S. Patent Publication No. US 2010/0035128, published on Feb. 11, 2010, filed as application Ser. No. 12/535,328 on Aug. 4, 2009, patented as U.S. Pat. No. 9,105,938 on Aug. 11, 2015, and entitled “Application of Force in Electrochemical Cells”; U.S. Patent Publication No. US 2011/0165471, published on Jul. 15, 2011, filed as application Ser. No. 12/180,379 on Jul. 25, 2008, and entitled “Protection of Anodes for Electrochemical Cells”; U.S. Patent Publication No. US 2006/0222954, published on Oct. 5, 2006, filed as application Ser. No. 11/452,445 on Jun. 13, 2006, patented as U.S. Pat. No. 8,415,054 on Apr. 9, 2013, and entitled “Lithium Anodes for Electrochemical Cells”; U.S. Patent Publication No. US 2010/0239914, published on Sep. 23, 2010, filed as application Ser. No. 12/727,862 on Mar. 19, 2010, and entitled “Cathode for Lithium Battery”; U.S. Patent Publication No. US 2010/0294049, published on Nov. 25, 2010, filed as application Ser. No. 12/471,095 on May 22, 2009, patented as U.S. Pat. No. 8,087,309 on Jan. 3, 2012, and entitled “Hermetic Sample Holder and Method for Performing Microanalysis under Controlled Atmosphere Environment”; U.S. Patent Publication No. US 2011/00765560, published on Mar. 31, 2011, filed as application Ser. No. 12/862,581 on Aug. 24, 2010, and entitled “Electrochemical Cells Comprising Porous Structures Comprising Sulfur”; U.S. Patent Publication No. US 2011/0068001, published on Mar. 24, 2011, filed as application Ser. No. 12/862,513 on Aug. 24, 2010, and entitled “Release System for Electrochemical Cells”; U.S. Patent Publication No. US 2012/0048729, published on Mar. 1, 2012, filed as application Ser. No. 13/216,559 on Aug. 24, 2011, and entitled “Electrically Non-Conductive Materials for Electrochemical Cells”; U.S. Patent Publication No. US 2011/0177398, published on Jul. 21, 2011, filed as application Ser. No. 12/862,528 on Aug. 24, 2010, and entitled “Electrochemical Cell”; U.S. Patent Publication No. US 2011/0070494, published on Mar. 24, 2011, filed as application Ser. No. 12/862,563 on Aug. 24, 2010, and entitled “Electrochemical Cells Comprising Porous Structures Comprising Sulfur”; U.S. Patent Publication No. US 2011/0070491, published on Mar. 24, 2011, filed as application Ser. No. 12/862,551 on Aug. 24, 2010, and entitled “Electrochemical Cells Comprising Porous Structures Comprising Sulfur”; U.S. Patent Publication No. US 2011/0059361, published on Mar. 10, 2011, filed as application Ser. No. 12/862,576 on Aug. 24, 2010, patented as U.S. Pat. No. 9,005,009 on Apr. 14, 2015, and entitled “Electrochemical Cells Comprising Porous Structures Comprising Sulfur”; U.S. Patent Publication No. US 2012/0070746, published on Mar. 22, 2012, filed as application Ser. No. 13/240,113 on Sep. 22, 2011, and entitled “Low Electrolyte Electrochemical Cells”; U.S. Patent Publication No. US 2011/0206992, published on Aug. 25, 2011, filed as application Ser. No. 13/033,419 on Feb. 23, 2011, and entitled “Porous Structures for Energy Storage Devices”; U.S. Patent Publication No. 2013/0017441, published on Jan. 17, 2013, filed as application Ser. No. 13/524,662 on Jun. 15, 2012, patented as U.S. Pat. No. 9,548,492 on Jan. 17, 2017, and entitled “Plating Technique for Electrode”; U.S. Patent Publication No. US 2013/0224601, published on Aug. 29, 2013, filed as application Ser. No. 13/766,862 on Feb. 14, 2013, patented as U.S. Pat. No. 9,077,041 on Jul. 7, 2015, and entitled “Electrode Structure for Electrochemical Cell”; U.S. Patent Publication No. US 2013/0252103, published on Sep. 26, 2013, filed as application Ser. No. 13/789,783 on Mar. 8, 2013, patented as U.S. Pat. No. 9,214,678 on Dec. 15, 2015, and entitled “Porous Support Structures, Electrodes Containing Same, and Associated Methods”; U.S. Patent Publication No. US 2013/0095380, published on Apr. 18, 2013, filed as application Ser. No. 13/644,933 on Oct. 4, 2012, patented as U.S. Pat. No. 8,936,870 on Jan. 20, 2015, and entitled “Electrode Structure and Method for Making the Same”; U.S. Patent Publication No. US 2014/0123477, published on May 8, 2014, filed as application Ser. No. 14/069,698 on Nov. 1, 2013, patented as U.S. Pat. No. 9,005,311 on Apr. 14, 2015, and entitled “Electrode Active Surface Pretreatment”; U.S. Patent Publication No. US 2014/0193723, published on Jul. 10, 2014, filed as application Ser. No. 14/150,156 on Jan. 8, 2014, patented as U.S. Pat. No. 9,559,348 on Jan. 31, 2017, and entitled “Conductivity Control in Electrochemical Cells”; U.S. Patent Publication No. US 2014/0255780, published on Sep. 11, 2014, filed as application Ser. No. 14/197,782 on Mar. 5, 2014, patented as U.S. Pat. No. 9,490,478 on Nov. 6, 2016, and entitled “Electrochemical Cells Comprising Fibril Materials”; U.S. Patent Publication No. US 2014/0272594, published on Sep. 18, 2014, filed as application Ser. No. 13/833,377 on Mar. 15, 2013, and entitled “Protective Structures for Electrodes”; U.S. Patent Publication No. US 2014/0272597, published on Sep. 18, 2014, filed as application Ser. No. 14/209,274 on Mar. 13, 2014, and entitled “Protected Electrode Structures and Methods”; U.S. Patent Publication No. US 2014/0193713, published on Jul. 10, 2014, filed as application Ser. No. 14/150,196 on Jan. 8, 2014, patented as U.S. Pat. No. 9,531,009 on Dec. 27, 2016, and entitled “Passivation of Electrodes in Electrochemical Cells”; U.S. Patent Publication No. US 2014/0272565, published on Sep. 18, 2014, filed as application Ser. No. 14/209,396 on Mar. 13, 2014, and entitled “Protected Electrode Structures”; U.S. Patent Publication No. US 2015/0010804, published on Jan. 8, 2015, filed as application Ser. No. 14/323,269 on Jul. 3, 2014, and entitled “Ceramic/Polymer Matrix for Electrode Protection in Electrochemical Cells, Including Rechargeable Lithium Batteries”; U.S. Patent Publication No. US 2015/044517, published on Feb. 12, 2015, filed as application Ser. No. 14/455,230 on Aug. 8, 2014, and entitled “Self-Healing Electrode Protection in Electrochemical Cells”; U.S. Patent Publication No. US 2015/0236322, published on Aug. 20, 2015, filed as application Ser. No. 14/184,037 on Feb. 19, 2014, and entitled “Electrode Protection Using Electrolyte-Inhibiting Ion Conductor”; and U.S. Patent Publication No. US 2016/0072132, published on Mar. 10, 2016, filed as application Ser. No. 14/848,659 on Sep. 9, 2015, and entitled “Protective Layers in Lithium-Ion Electrochemical Cells and Associated Electrodes and Methods”.

The following examples are intended to illustrate certain embodiments of the present disclosure but are not to be construed as limiting and do not exemplify the full scope of the invention.

### Example 1

The following example describes the preparation of a conductive release layer formed on nickel foil.

To a solution of 8 wt % polysulfone ultrason 6010 (BASF) in DOL was added 3 wt % multi walled carbon nanotubes (Aldrich) and 3 wt % Vulcan carbon. The slurry was ball-milled using metal balls for 16 hours. The slurry was coated onto Ni foil using a doctor blade with a gap of 76 μm. The film was air dried for 5 minutes, and dried in an oven at 105° C. for 15 min.

The film was releasable from the foil with a peel force of 12.26 N/m (measured in each example using MARK-10 BG5 gauge with ESM301 motorized test stand), a thickness of 3 μm, and an electrical resistivity of 432.741 kOhm·cm.

### Example 2

The following example describes the preparation of another conductive release layer formed on nickel foil.

To a solution of 8 wt % polysulfone ultrason 6010 (BASF) in DOL was added 3 wt % multi walled carbon nanotubes (Aldrich) and 5 wt % Vulcan carbon. The slurry was ball-milled using metal balls for 16 hours. The slurry was coated onto Ni foil using a doctor blade with a gap of 51 μm. The film was air dried for 5 minutes, and dried in an oven at 105° C. for 15 min.

The film was releasable from the foil with a peel force of 0.175 N/m and a thickness of 2 μm.

### Example 3

The following example describes the preparation of a conductive release layer formed on aluminum foil.

To a solution of 8 wt % polysulfone ultrason 6010 (BASF) in DOL was added 3 wt % multi walled carbon nanotubes (Aldrich) and 25 wt % Vulcan carbon. The slurry was ball-milled using metal balls overnight. The slurry was coated onto Al foil using a doctor blade with a gap of 102 μm. The film was air dried for 5 minutes, and dried in an oven at 105° C. for 15 min.

The film was releasable from the foil with a peel force of 35.0 N/m, a thickness of 6 μm, and an electrical resistance of 0.059 kOhm·cm.

### Example 4

The following example describes the preparation of another conductive release layer formed on aluminum foil.

To a solution of 6.5 wt % polysulfone ultrason 6010 (BASF) in DOL was added 3 wt % multi walled carbon nanotubes (Aldrich) and 20 wt % Vulcan carbon. The slurry was ball-milled using metal balls overnight. The slurry was coated onto Al foil using a doctor blade with a gap of 102 μm. The film was air dried for 5 minutes, and dried in an oven at 105° C. for 15 min.

The film was releasable from the foil with a peel force of 45.3 N/m, a thickness of 5 μm, and an electrical resistance of 1.602 kOhm·cm.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A conductive release layer for releasing an electrode from a substrate, comprising:
a plurality of conductive carbon species comprising:
a plurality of conductive carbon particles, and
a plurality of elongated carbon structures; and
a polymeric binder.

2. A conductive release layer for releasing an electrode from a substrate, comprising:
a plurality of conductive carbon species comprising elemental carbon; and
a polymeric binder,
wherein the plurality of conductive carbon species is present in an amount of greater than or equal to 15 wt % of the conductive release layer.

3. An electrode, comprising:
an electroactive layer; and
a conductive release layer adjacent to the electroactive layer,
wherein the conductive release layer comprises a plurality of conductive carbon species, and
wherein the conductive carbon species comprises elemental carbon.

4. An electrode, comprising:
an electroactive layer; and
a conductive release layer,
wherein the conductive release layer comprises a polymeric binder and a plurality of conductive carbon species, and
wherein the plurality of conductive carbon species is present in an amount of greater than or equal to 15 wt % relative to an amount of the polymeric binder.

5. An electrode, comprising:
a first electroactive layer;
a first conductive release layer comprising a plurality of conductive carbon species; and
a second electroactive layer,
wherein the first conductive release layer is between the first electroactive layer and the second electroactive layer, and
wherein the first electroactive layer is in electronic communication with the second electroactive layer.

6. A method, comprising:
dissolving a polymeric binder in a solvent to form a solution;
adding a plurality of conductive carbon species to the solution to form a slurry;
dispersing the plurality of conductive carbon species within the slurry;
evaporating the solvent from the slurry to form a conductive release layer; and
depositing a current collector or an electroactive layer on the conductive release layer.

7. The conductive release layer, electrode, or method of any one of the preceding claims, further comprising a current collector, optionally wherein the current collector is positioned adjacent the electroactive layer and the conductive release layer.

8. The conductive release layer, electrode, or method of any one of the preceding claims, further comprising a second current collector.

9. The conductive release layer, electrode, or method of any one of the preceding claims, wherein the conductive release layer is directly adjacent to the electroactive layer.

10. The conductive release layer, electrode, or method of any one of the preceding claims, wherein the conductive carbon species comprises elemental carbon.

11. The conductive release layer, electrode, or method of any one of the preceding claims, wherein the conductive carbon particles comprise Vulcan carbon and/or carbon black.

12. The conductive release layer, electrode, or method of any one of the preceding claims, wherein the elongated carbon structures comprise carbon nanotubes, multi-walled carbon nanotubes, and/or carbon fibers.

13. The conductive release layer, electrode, or method of any one of the preceding claims, wherein the conductive release layer comprises a polymeric binder.

14. The conductive release layer, electrode, or method of any one of the preceding claims, wherein the conductive release layer is adjacent to a metal foil, and optionally wherein the metal foil comprises aluminum, nickel, copper and/or iron.

15. The conductive release layer, electrode, or method of any one of the preceding claims, wherein the conductive release layer comprises an RMS surface roughness of greater than or equal to 1 micron and/or less than or equal to 5 microns.

16. The conductive release layer, electrode, or method of any one of the preceding claims, wherein the conductive carbon species is present in an amount of greater than or equal to 15 wt % relative to the polymeric binder.

17. The conductive release layer, electrode, or method of any one of the preceding claims, wherein a mass ratio of the conductive carbon species to the polymeric binder is greater than or equal to 1:1.

18. The conductive release layer, electrode, or method of any one of the preceding claims, wherein a mass ratio of the conductive carbon particles to the elongated carbon structures is greater than or equal to 1:1.

19. The conductive release layer, electrode, or method of any one of the preceding claims, wherein a mass ratio of the total amount of conductive carbon species to the elongated carbon is less than or equal 9:1.

20. The conductive release layer, electrode, or method of any one of the preceding claims, wherein the plurality of conductive carbon particles comprises an average particle size less than or equal 10 microns and/or greater than or equal to 50 nm.

21. The conductive release layer, electrode, or method of any one of the preceding claims, wherein the polymeric binder comprises a polymer, optionally wherein the polymer comprises polysulfone.

22. The conductive release layer, electrode, or method of any one of the preceding claims, wherein the conductive release layer comprises a thickness of less than or equal 5 microns and/or greater than or equal to 0.5 microns.

23. The conductive release layer, electrode, or method of any one of the preceding claims, wherein the conductive release layer comprises an electrical resistivity of less than or equal 1,000 kOhm·cm.

24. The conductive release layer, electrode, or method of any one of the preceding claims, wherein the current collector comprises a metal such as aluminum, copper, chromium, nickel and/or stainless steel.

25. The conductive release layer, electrode, or method of any one of the preceding claims, wherein the electroactive layer comprises lithium.

26. The conductive release layer, electrode, or method of any one of the preceding claims, wherein the plurality of conductive carbon species comprises a plurality of conductive carbon particles and a plurality of elongated carbon structures.

27. The method of any one of the preceding claims, wherein dispersing comprises milling the slurry containing the plurality of conductive carbon species, optionally wherein milling comprises ball milling the slurry, and optionally wherein ball milling comprises ball milling with a plurality of metal balls.

28. The method of any one of the preceding claims, further comprising coating a substrate with the slurry, optionally wherein coating the substrate comprises doctor blading.

29. The method of any one of the preceding claims, wherein the solvent comprises an ether-based solvent, optionally wherein the solvent comprises dioxolane.

30. The method of any one of the preceding claims, further comprising stirring the slurry.

31. The method of any one of the preceding claims, wherein evaporating comprises drying in an oven.
